(19) United States
(12) Patent Application Publication
(10) Pub. No.: US 2013/0185752 A1
(43) Pub. Date: Jul. 18, 2013

(54) Wireless Terminal, System and Information Processing Method

(71) Applicants: Tsuguo Itagaki, Yokohama (JP); Michihito Yamato, Yokohama (JP); Takehiro Uzawa, Kamakura (JP)

(72) Inventors: Tsuguo Itagaki, Yokohama (JP); Michihito Yamato, Yokohama (JP); Takehiro Uzawa, Kamakura (JP)

(73) Assignee: Hitachi Consumer Electronics Co., Ltd.

(21) Appl. No.: 13/553,378

(22) Filed: Jul. 19, 2012

(30) Foreign Application Priority Data
Sep. 28, 2011 (JP) 2011-211878

(51) Int. Cl. H04N 21/472

(52) U.S. Cl. CPC H04N 21/472
USPC 725/39; 725/58

(57) ABSTRACT

A recording apparatus comprises a broadcasting-wave receiving device which receives broadcasting waves containing identification information for specifying program and video and audio information of program, a program reservation device which prepares, when setting of a program contained in broadcasting waves is received, reservation information containing identification information of program of which setting is received and information concerning setting, a wireless terminal, a communication device of the wireless terminal which transmits and receives reservation information and a recording device which records video and audio information of program identified by identification information contained in reservation information on the basis of information concerning setting.

### INCORPORATION BY REFERENCE

The present application claims priority from Japanese application JP2011-211878 filed on Sep. 28, 2011, the content of which is hereby incorporated by reference into this application.

### BACKGROUND OF THE INVENTION

The present invention relates to a network terminal system and terminal device.

As a background technique of this technical field, JP-A-2009-055614 may be referred to. This publication discloses that “interactive communication can be made between a remote controller and an object apparatus to be operated, so that exact communication can be made by confirmation of delivery, complicated command system utilizing GUI (Graphical User Interface) can be managed and relatively broad band can be utilized to transmit a large capacity of data such as streaming of moving picture.”

The publication of JP-A-2009-055614 also discloses the method that a wireless remote controller connected to a network is used to transfer program information received by a display to the wireless remote controller and display EPG (Electronic Program Guide) in wireless remote controller. However, in case of the invention disclosed in JP-A-2009-055614, there is a problem that since program information on the side of display is used, an amount of data to be transferred of program information is increased and display operation is slow since all data cannot be obtained once. Furthermore, a confirmation method of a program being viewed on television and a reserved program for recording is not disclosed. Moreover, a method of changing recording reservation is not disclosed.

In order to solve the above problems, composition described in claims is adopted, for example.

According to the present invention, when a viewer is viewing television broadcast, program guide can be displayed on another terminal device, so that program reservation can be made without preventing viewing of television.

Other problems except the above-mentioned, configuration and effects are made apparent from description of the following embodiments.

### BRIEF DESCRIPTION OF THE DRAWINGS

FIG. 1A shows an example of a block diagram schematically illustrating a network terminal system;

FIG. 1B shows an example of a block diagram schematically illustrating a television receiver;

FIG. 1C shows an example of a block diagram schematically illustrating a wireless terminal;

FIG. 1D shows an example of configuration of a storage and a memory used in the television receiver;

FIG. 1E shows an example of configuration of a storage and a memory used in the wireless terminal;

FIG. 2 shows an example of data format of program state information;

FIG. 3 shows an example of detailed attributes of program state information;

FIG. 4 is a flowchart showing an example of operation sequence of making distinguishable indication peculiar to EPG;

FIG. 5 shows an example of a picture of EPG displayed in the television receiver;

FIG. 6 shows an example of a picture of EPG displayed in the wireless terminal;

FIG. 7 shows an example of a picture of EPG displayed in the wireless terminal;

FIG. 8 shows an example of a picture of EPG displayed in the wireless terminal when EPG is started;

FIG. 9 shows an example of configuration of storage and memory of the wireless terminal;

FIG. 10 shows an example of data format of reservation information;

FIG. 11 shows a modification example of data format of reservation information;

FIG. 12 is a flowchart showing an example of operation sequence at the time of program reservation using EPG;

FIG. 13 shows a display example of reservation setting screen when program having recording reservation mark added thereto is selected;

FIG. 14 shows a display example of detailed reservation setting screen;

FIG. 15 shows an example of reservation setting screen displayed when program being broadcasted is selected;

FIG. 16A shows an example of configuration of storage and memory used in television receiver;

FIG. 16B shows an example of configuration of storage and memory used in wireless terminal;

FIG. 17 shows a display example of EPG screen displayed when program is selected in EPG screen;

FIG. 18 shows a display example of reservation setting screen on connection apparatus which is authenticated presently;

FIG. 19 shows a display example of reservation setting screen on connection apparatus which is not authenticated presently;

FIG. 20 shows a display example of detailed reservation setting screen on connection apparatus which is not authenticated presently;

FIG. 21A shows an example of channel allocation information;

FIG. 21B shows an example of channel allocation information;

FIG. 22 shows an example of configuration of storage and memory used in television receiver;

FIG. 23 is a flowchart showing an example of operation sequence at the time of program reservation using program guide;

FIG. 24 shows a display example of reservation setting screen;

FIG. 25 shows a display example of detailed reservation setting screen;

FIG. 26 shows a display example of reservation state information;

FIG. 27 shows an example of data format of reservation information according to the eighth embodiment;

FIG. 28 is a flowchart showing an example of operation sequence at the time of program reservation using EPG;

FIG. 29 is a flowchart showing an example of operation sequence at the time that program reservation contents are changed;

FIG. 30 shows a display example of EPG screen at the time that program having program reservation mark added thereto is selected;

FIG. 31 shows a display example of reservation setting screen;

FIG. 32 shows a display example of detailed reservation setting screen;

FIG. 33 shows a display example of reservation state information;

FIG. 34 shows an example of configuration of storage and memory used in wireless terminal;

FIG. 35 shows an example of data format of reservation information;

FIG. 36 is a flowchart showing an example of operation sequence at the time of program reservation using EPG;

FIG. 37 shows a display example of EPG screen at the time that program having no program reservation mark is selected;

FIG. 38 shows a display example of reservation setting screen;

FIG. 39 shows a display example of detailed reservation setting screen; and

Fig. 40 shows a display example at the time that a list of program reservation is displayed in wireless terminal.

### DETAILED DESCRIPTION OF THE INVENTION

Embodiments of the present invention are now described with reference to the accompanying drawings.

### Embodiment 1

The following description is made by taking a network terminal system including television receivers having digital broadcasting receiving function and which receive digital broadcasting waves containing service information (event information) and display electronic program guide (EPG) of digital broadcasting on the basis of the received service information and wireless devices as an example.

In BS digital broadcasting, CS digital broadcasting and terrestrial digital television broadcasting operated in Japan, plural transport streams (hereinafter abbreviated to “TS”) are multiplexed to one transponder (frequency channel) to be transmitted. TS has data structure conforming to the standard of the Association of Radio Industries and Businesses (ARIB) and is composed of TS packets having service information of event information added as a header with elementary streams (ES) as contents data.

The data structure of service information conforms to ARIB STD-B10 “Standard of service information for digital broadcasting system” which is the standard of ARIB. The service information includes PSI (Program Specific Information) which is transmission control information specified in the standard of MPEG (Moving Picture Expert Group)-2 system and SI (Service Information) for constructing EPG and the like.

SI includes four tables of BIT (Broadcaster Information Table), SDT (Service Description Table), EIT (Event Information Table) and TOT (Time Offset Table).

BIT describes information concerning broadcasters or broadcasting stations in network. SDT is divided into TS information part and service information part. The TS information part includes network ID for identifying network and TS ID (identifiers) for identifying TS.

BS network, CS1 network and CS2 network are allocated different network ID's. In case of terrestrial digital broadcasting, different network ID's are allocated to respective broadcasting stations in the same area. The service information part includes service ID's (so-called channel numbers) which are identifiers for identifying individual services (channels) in network.

EIT describes program information for each event (so-called program) and is divided into service information part and event information part. The service information part includes service ID's (so-called channel numbers) which are identifiers for identifying individual services (channels) in network. The event information part includes event ID's, event start time, event duration, event name (so-called program title) and event genres. TOT describes present time.

The first embodiment according to the present invention is now described.

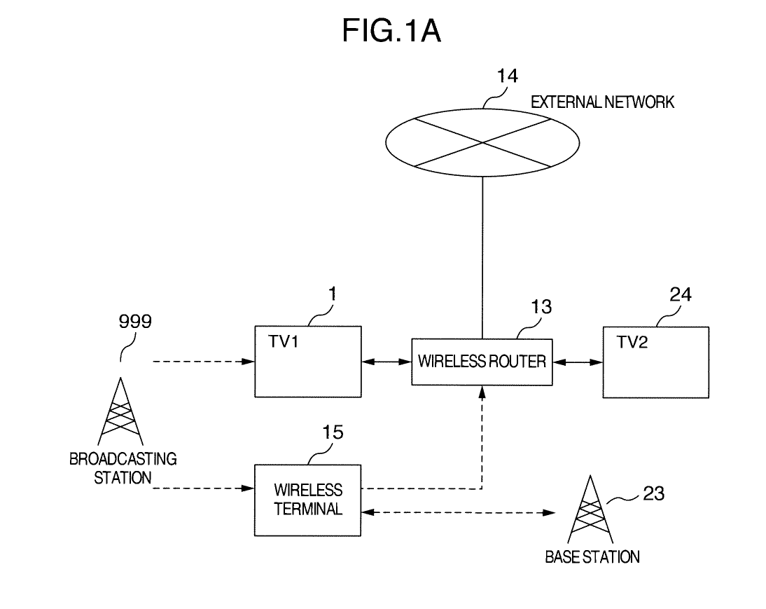

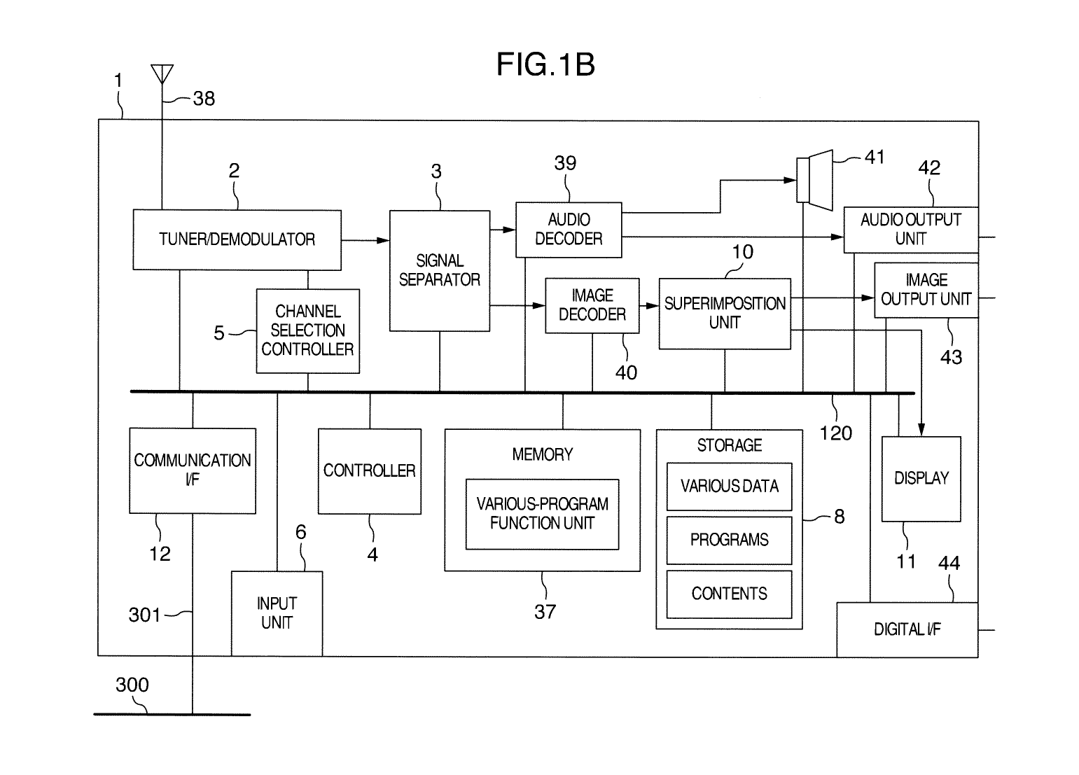

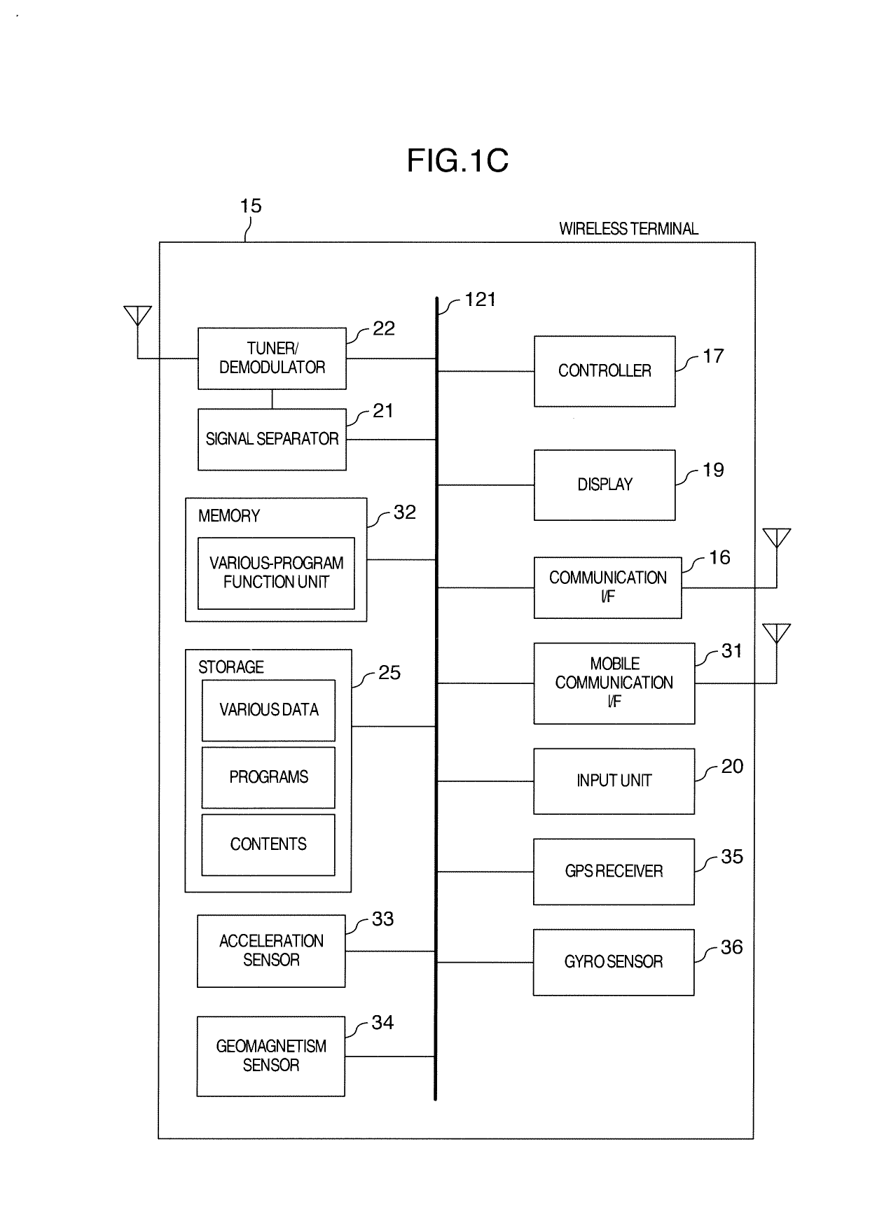

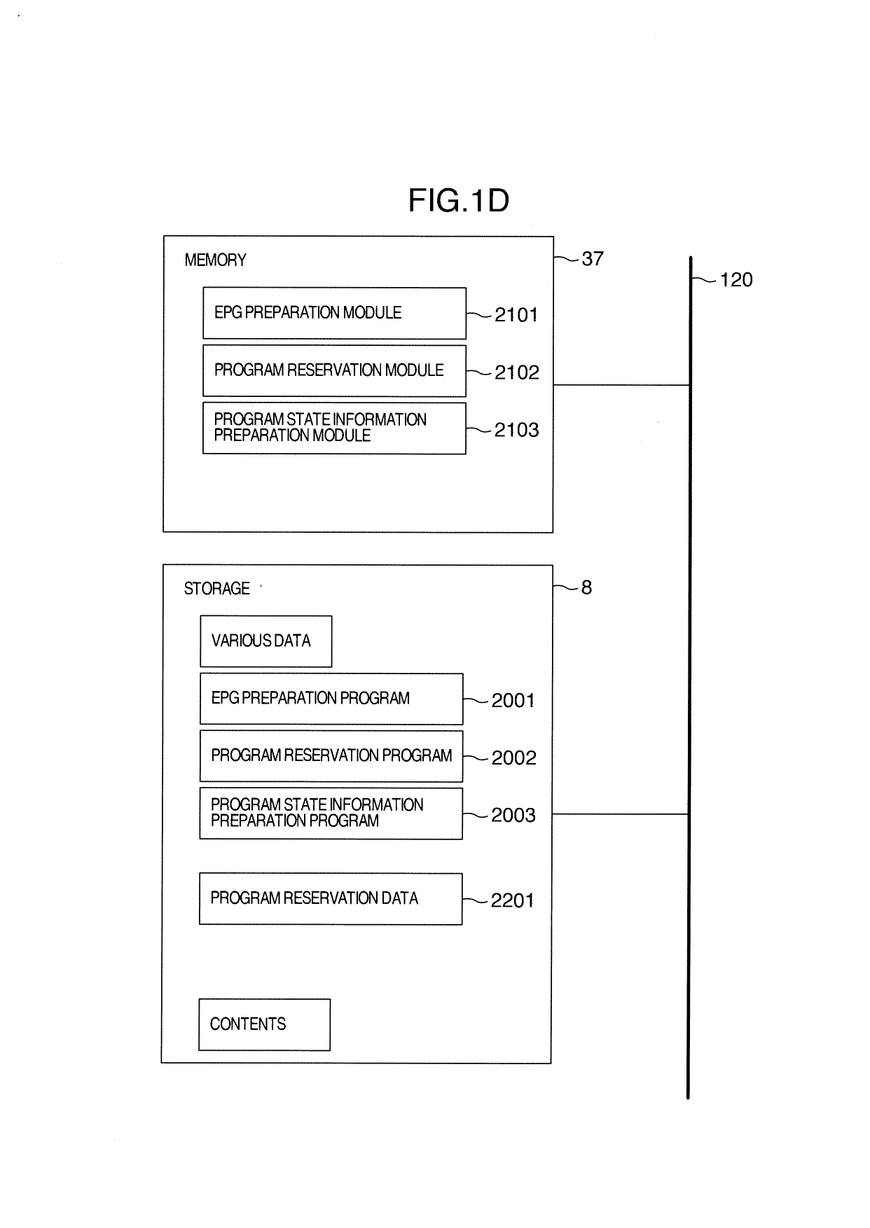

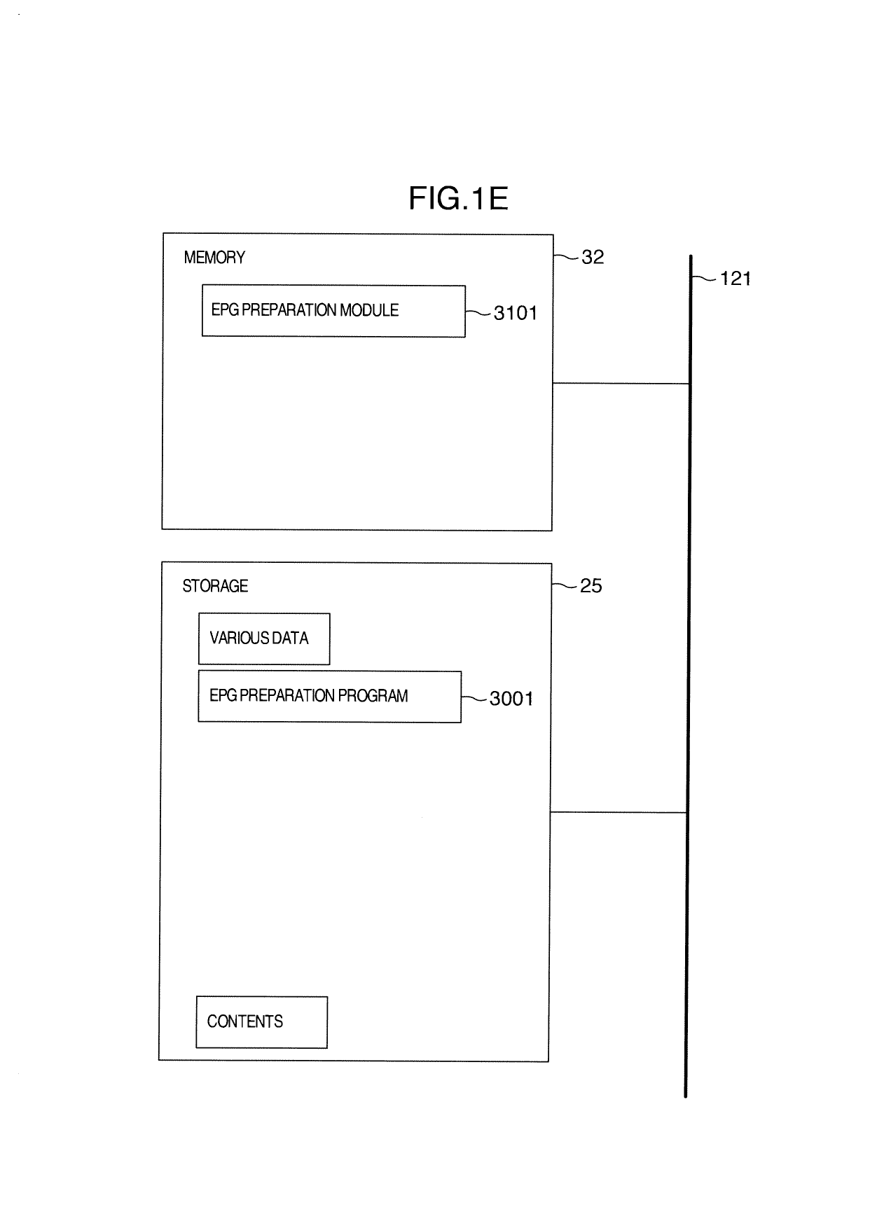

FIG. 1A is a block diagram schematically illustrating a network terminal system according to the first embodiment.

The network terminal system of the embodiment includes, for example, a television receiver 1, a wireless terminal 15, a wireless router 13 and an external network 14. This example shows the case where a user of the wireless terminal 15 which is a mobile communication terminal such as a portable telephone functioning as an information communication terminal is viewing a television program by the television receiver 1 at home or store while holding the wireless terminal 15.

The wireless router 13 has wireless LAN (Local Area Network) function such as Wi-Fi (trademark) and can be connected to the external network via communication line. Further, the wireless router 13 is connected to television receivers 1 and 24, wireless terminal 15 and external network 14, and television receivers 1 and 24 and wireless terminal 15 can obtain information from the Internet.

Furthermore, it is supposed that wireless router 13 is connected to television receivers 1 and 24 by wired or wireless LAN and is connected to wireless terminal 15 by wireless LAN. Wi-Fi is the standard of wireless LAN formulated by the standard “IEEE 802.11a/IEEE 802.11b” of IEEE (the Institute of Electrical and Electronics Engineers, Inc.).

FIG. 1B is a block diagram schematically illustrating the television receiver 1.

The television receiver 1 is connected to an antenna 38 and includes a tuner/demodulator 2, a signal separator 3, a controller 4, a channel selection controller 5, input unit 6, a storage 8, a memory 37, a superimposition unit 10, a display 11, a communication (Interface) 12, an audio decoder 39, an video decoder 40, a loudspeaker 41, an audio output unit 42 and an video output unit 43. The above processing units are connected one another through a bus 120.

Further, the television receiver 1 can store application programs in storage 8 and the controller 4 can read out the programs from storage 8 to be developed into memory 37, so that the controller 4 can execute the programs to realize various functions. In the following description, for simplification of description, various functions realized by execution of the application programs by the controller 4 are supposed to be realized by various program function modules independently.

Furthermore, the application programs may be stored in storage 8 in advance until television receiver 1 is shipped or may be stored in optical medium, semiconductor memory or the like such as CD (Compact Disk) and DVD (Digital Versatile Disk) to be installed in television receiver 1 by means of a medium connection unit not shown. Moreover, the application programs may be downloaded from external network 14 through communication I/F 12 and wireless router 13 to be installed in television receiver 1.

Further, various functions of application programs can be realized in hardware as processing units for realizing the same functions. When the various functions are realized in hardware, the processing units realize the functions independently.

The input unit 6 receives user's operation to television receiver 1 to input control information in accordance with input operation and is realized by remote controller, keyboard, pointing device such as mouse and the like, for example.

The controller 4 receives user's operation request through input unit 6 and controls signal separator 3, channel selection controller 5, storage 8, superimposition unit 10, communication I/F 12 and various-program function module.

The storage 8 is controlled in accordance with instructions from controller 4 and can store therein application programs. Further, the storage 8 stores therein various information prepared by application programs. In addition, the storage 8 may store therein contents such as video/audio stream from signal received from tuner/demodulator 2 and communication I/F 12.

The memory 37 is controlled in accordance with instructions from controller 4. Function modules of application programs stored in storage 8 are loaded into memory 37.

The tuner/demodulator 2 is timed to the channel of desired service by channel selection controller 5 to receive broadcasting signal from broadcasting station and demodulates the received broadcasting signal to get transport stream.

The channel selection controller 5 receives instructions for selecting service through input unit 6 and controls tuner/demodulator 2 so as to change channel to be selected in accordance with the instructions. Further, the channel selection controller 5 can receive instructions from various-program function modules and controls tuner/demodulator 2 so as to make change by a unit of the service (channel number), which is broadcasting the event (program) on air at present and presentation of the broadcast, to which that service belongs.

The communication I/F 12 is connected to wireless router 13 by means of wired LAN or wireless LAN. Further, communication I/F 12 can communicate with external apparatuses directly without using wireless router 13 by means of IrDA (trademark), Bluetooth (trademark), NFC (Near Field Communication) or the like. Communication I/F 12 may be plural in number so that each chip performs different communication system or may be single so that one chip deals with plural communication systems. Communication I/F 12 transmits and receives various information to and from television receiver 24 and wireless terminal 15. Moreover, communication I/F 12 can transmit and receives various information to and from apparatuses connected to external network. For example, communication I/F 12 can receive IP broadcasting and contents stream (video/audio stream) in the form of video on demand from server connected to external network. Further, communication I/F 12 can download video stream and application program from server connected to external network. The downloaded information is stored in storage 8, for example.

The signal separator 3 separates transport stream obtained by tuner/demodulator 2 and contents stream obtained through communication I/F 12 for each kind of video data, audio data, subtitle data, program information and the like. Further, signal separator 3 has function of obtaining program information (for example, service information SI) and transmitting it to another processing block. Moreover, when signal separator 3 receives data transmission request from another processing unit, signal separator 3 transmits data designated by the request to request source.

The audio decoder 39 decodes audio data separated by signal separator 3. Audio information decoded by audio decoder 39 is outputted from loudspeaker 41. Audio information decoded by audio decoder 39 may be sent to external apparatus from audio output unit 42.

The video decoder 40 decodes video data separated by signal separator 3. Video information decoded by video decoder 40 is sent to superimposition unit 10.

The superimposition unit 10 superimposes EPG image and OSD image produced by various-program function module and image produced from various information (subtitle information, subtitle superimposition, data broadcasting data and the like) separated by signal separator 3 on decoded video information sent from video decoder 40.

Image or video information passing through superimposition unit 10 is displayed on display 11. Display 11 is formed of for example, display of television receiver and personal computer or liquid crystal panel. Image or video information passing through superimposition unit 10 may be outputted to external apparatuses from video output unit 43.

Furthermore, a digital I/F 44 may be provided to output transport stream for predetermined program separated by signal separator 3 without decoding video and audio.

The television receiver 24 has the same configuration as that of television receiver 1 and description thereof is omitted. In the embodiment, television receiver 1 is described, although the television receiver 1 may be replaced by recorder or the like and in this case the loudspeaker 41 and display 11 can be omitted from configuration of the television receiver of FIG. 1B.

FIG. 1C is a block diagram schematically illustrating the wireless terminal 15. The wireless terminal 15 includes, for example, a communication I/F 16, a controller 17 a display 19, input unit 20, a signal separator 21, a tuner/demodulator 22, a storage 25, a mobile communication I/F 31, a memory 32 an acceleration sensor 33, a geomagnetism sensor 34, a GPS receiver 35 and a gyro sensor 36, and the above processing units are connected one another through a bus 121.

Further, the wireless terminal 15 stores application programs in storage 25 and the controller 17 can load the programs from storage 25 into memory 32 and execute the programs to realize various functions. In the following description, for simplification of description, various functions realized by execution of the programs by the controller 17 are supposed to be realized by various-program function module independently.

Furthermore, application programs may be stored in storage 25 beforehand until wireless terminal 15 is shipped or may be stored in optical medium, semiconductor memory or the like such as CD (Compact Disk) and DVD (Digital Versatile Disk) to be installed in wireless terminal 15 by means of a media connection unit not shown. Moreover, the application programs may be downloaded from external network 14 through communication I/F 16 and wireless router 13 to be installed in wireless terminal 15. Alternatively, the application programs may be downloaded through mobile communication I/F 31 from distribution source via base station 23. Further, the wireless terminal can be connected through external apparatus connection I/F not shown to personal computer (PC) which has obtained application programs via network and the application programs can be moved or copied to wireless terminal 15 from personal computer to be installed in wireless terminal 15.

Further, application programs can be realized in hardware as processing units for realizing the same functions. When application programs are realized in hardware, the processing units realize the functions independently.

The communication I/F 16 can communicate with external apparatuses directly without using wireless router 13 by means of wireless LAN such as Wi-Fi etc., IrDA, Bluetooth, NFC (Near Field Communication) or the like. The communication I/F 16 transmits and receives various information to and from communication I/F 12 of television receiver 1. Further, communication I/F 16 is connected to external network and makes transmission and reception of information with server or the like on external network. Communication I/F 16 may be plural in number so that each communication I/F performs different communication system as communication I/F dedicated to Wi-Fi or may be mounted as a chip which deals with plural communication systems.

The mobile communication I/F 31 can utilize mobile communication network such as GSM (Global System for Mobile Communications: trademark), W-CDMA (Wideband Code Division Multiple Access: trademark), CDMA 2000 (Code Division Multiple Access: trademark) and LTE (Long Term Evolution: trademark) to be connected to communication network via base station 23 and can make transmission and reception of information with server on communication network.

The controller 17 receives user's operation request through input unit 20 and controls signal separator 21, display 19, communication I/F 16 and various-program function module.

The controller 17 has the function of extracting program information from external network 14 through communication I/F 16 and wireless router 13 or through mobile communication I/F 31 and base station 23 to obtain service information and delivering the service information to various-program function module.

In the embodiment, description is made by taking the case where program information of digital broadcasting is extracted by signal separator 21 to obtain service information SI as an example, although service information SI can be obtained from external network or distribution source through communication I/F 16 or mobile communication I/F 31. In this case, signal separator 21 and tuner/demodulator 22 can be omitted from configuration of wireless terminal 15.

The storage 25 is controlled by instructions of controller 17 and can store therein application programs. Further, the storage 25 stores therein various information prepared by application programs. In addition, the storage 25 may store therein contents such as video/audio stream extracted by tuner/demodulator 22, or received from, communication LF 16 or mobile communication I/F 31.

The storage 32 is controlled by instructions of controller 17. Function module of application programs stored in storage 25 is loaded into memory by controller 17.

The display 19 displays image or video. The image or video to be displayed may be picture produced by application program, be image or video of contents received through tuner/demodulator 22, be image or video received from server on external network through communication I/F 16, be image or video received from television receiver 1 through communication I/F 16 and be image or video distributed from server on communication network through mobile communication I/F 31. Further, the display 19 may be constructed integrally with touch screen described below, for example.

The input unit 20 receives user's operation for wireless terminal 15 to input control information concerning input operation and can use physical button or tough screen, for example.

The tuner/demodulator 22 and the signal separator 21 have the same function as tuner/demodulator 2 and signal separator 3 of television receiver 1, respectively.

The acceleration sensor 33 measures acceleration applied to wireless terminal 15. Controller 17 can understand which unit of wireless terminal 15 takes upper position on the basis of gravitational acceleration measured by acceleration sensor 33, for example, and display picture on display 19 so that upper part of the picture is set to correspond to the upper part of wireless terminal measured by acceleration sensor 33 to thereby display the picture to be matched to user's way of holding wireless terminal 15.

The geomagnetism sensor 34 utilizes plural magnetic sensors to measure geomagnetism.

The GPS receiver 35 utilizes GPS (Global Positioning System) to receive signal transmitted from plural satellites. Controller 17 can calculate positional information of wireless terminal 15 on the basis of signal received by GPS receiver 35. When service information SI is obtained from network through communication I/F or mobile communication I/F, for example, controller 17 can transmit positional information of wireless terminal 15 to transmission source of service information SI and transmission source of service information SI can transmit service information SI according to area where wireless terminal 15 exists to wireless terminal 15.

The gyro sensor 36 measures angular velocity of wireless terminal 15 produced when the user moves wireless terminal 15.

FIG. 1D is a schematic diagram illustrating storage 8 and memory 37 used in television receiver 1. In FIG. 1D, television receiver 1 includes program reservation data 2201, EPG preparation program 2001, program reservation program 2002 and program state information preparation program 2003 stored in storage 8 and controller 4 develops EPG preparation program 2001, program reservation program 2002 and program state information preparation program 2003 into memory 37 as EPG preparation module 2101, program reservation module 2102 and program state information preparation module 2103. EPG preparation program 2001 and program reservation program 2002 may be stored in storage 8 when the product is shipped or may be downloaded through communication I/F 12.

The program reservation data 2201 is information prepared by program reservation module 2102 and includes reservation information which is detailed information for setting of programs. The reservation information includes identification information containing network ID, service ID and event ID for uniquely specifying object programs of setting and reservation state information necessary for execution of recording reservation or viewing reservation containing information representative of viewing reservation or recording reservation, information representative of picture quality of recording and information representative of recording destination (storage 8, external storage connected to digital I/F 44 or the like) in case where object program is recorded.

The EPG preparation module 2101 obtains service information separated by signal separator 3 and allocates service ID's in the horizontal direction on the basis of the obtained service information, so that the EPG preparation module 2101 prepares electronic program guide in which program columns are arranged downward in time-series manner for each of service ID's. Part or all of detailed program contents contained in service information can be arranged in each program column of electronic program guide.

The program reservation module 2102 prepares GUI (Graphical User Interface) for making program reservation and prepares reservation information in accordance with contents inputted by the user to GUI by means of input unit 6 to be stored and managed in program reservation data 2201. Furthermore, when program reservation is understood to be viewing reservation in accordance with contents of reservation information described in program reservation data 2201, service ID of channel used to broadcast reserved program is transmitted to channel selection controller 5 when reservation time is reached and program designated by service ID transmitted is displayed on display 11. When program reservation is recording reservation, service ID of channel used to broadcast reserved program is also transmitted to channel selection controller 5 similarly, although video and audio decoded by video decoder 40 and audio decoder 39, respectively, are coded to be stored in storage 8 as contents.

The program state information preparation module 2103 obtains identification information of program having predetermined attribute from identification information described in service information SI separated by signal separator 3 and adds attribute to the obtained identification information to thereby prepare program state information.

FIG. 1E is a schematic diagram illustrating storage 25 and memory 32 used in wireless terminal 15. In FIG. 1E, EPG preparation program 3001 is stored in storage 25 and controller 17 loads EPG preparation program 3001 into memory 32 as EPG preparation module 3101. EPG preparation program 3001 may be stored in storage 25 when the product is shipped or may be downloaded through communication I/F 16 or mobile communication I/F 31.

The EPG preparation module 3101 is the same as the EPG preparation module 2101 of television receiver 1 and accordingly description thereof is omitted.

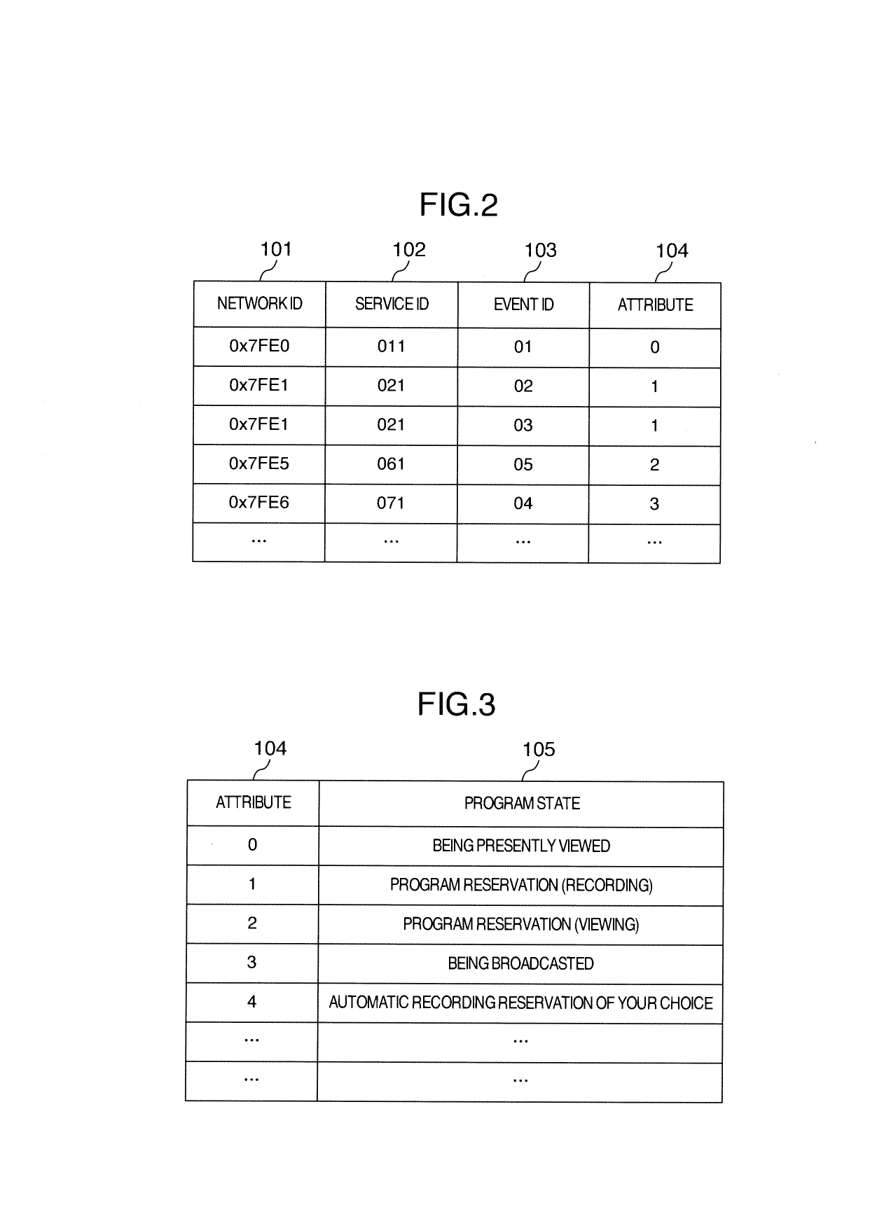

Referring now to FIGS. 2 and 3, data format related to the network terminal system of the embodiment is described.

FIG. 2 shows an example of data format of program state information.

The program state information has the format of network ID 101, service ID 102, event ID 103 and attribute 104 as shown in FIG. 2.

FIG. 3 shows an example of the details of attribute 104 of program state information shown in FIG. 2. Attribute 104 represents program state 105 of viewing or setting of television receiver 1. Program being presently broadcasted is “3”, program of channel to which tuner/demodulator 2 is timed by channel selection controller 5 and which is being presently broadcasted is “0” and programs having network ID, service ID and event ID registered in reservation information managed by program reservation module 2102 described later are “1”, “2” and “4”, where “1” is for recording reservation, “2” is for viewing reservation and “4” is for automatic recording reservation of your choice.

Referring now to FIGS. 1, 2, 3 and 4, an example of operation in case where input unit 20 receives user's operation and wireless terminal 15 displays EPG on display 19 is described.

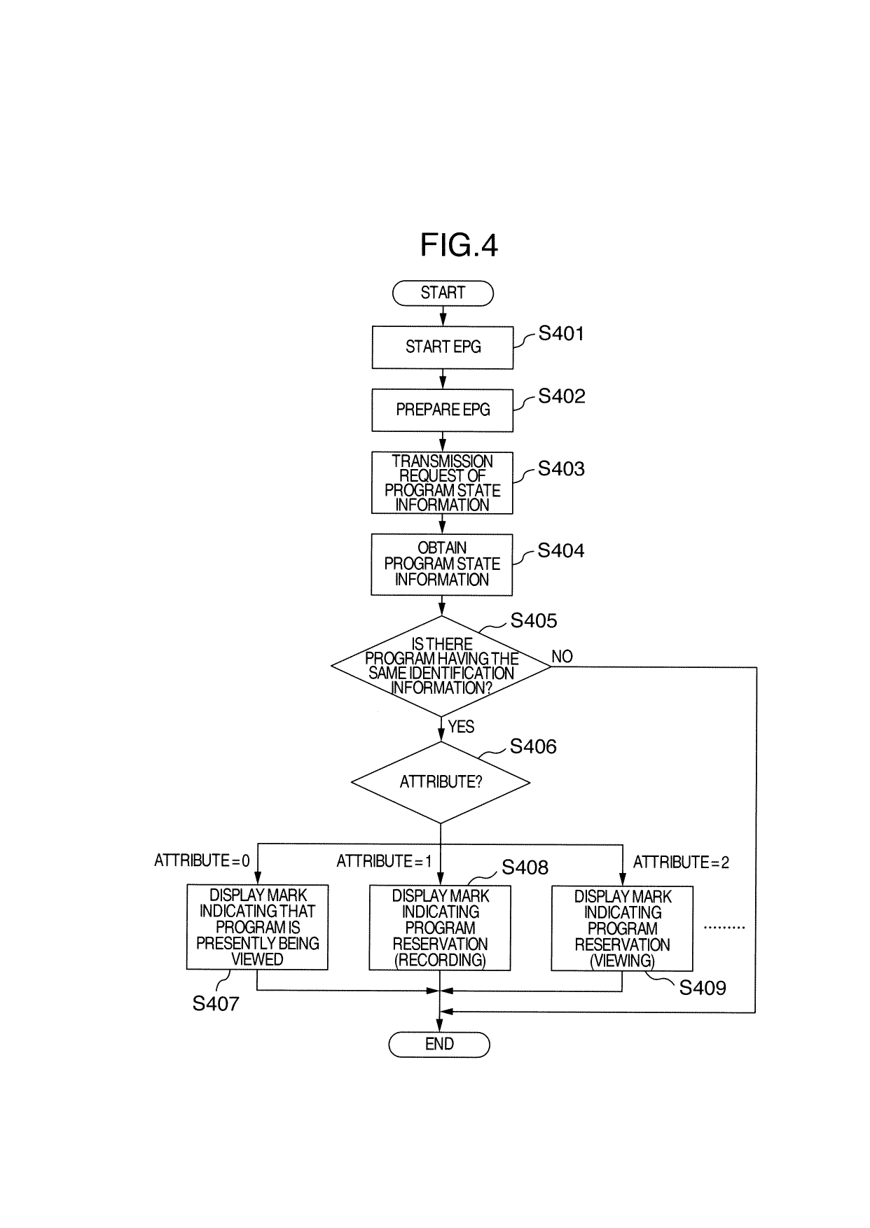

FIG. 4 is a flow chart showing an example of operation sequence of making distinguishable indication peculiar to EPG by EPG preparation module 3101.

When EPG preparation module 3101 receives EPG start instructions from input unit 20 (S401), EPG preparation module 3101 obtains service information SI separated by signal separator 21. EPG preparation module 3101 prepares EPG screen on the basis of EIT contained in service information SI (S402) to display EPG screen on display 19. EPG preparation module 3101 requests television receiver 1 to transmit program state information (S403).

When program state information preparation module 2103 receives transmission request of program state information, program state information preparation module 2103 refers to program reservation data 2201 stored in storage 8 to obtain identification information of programs for recording reservation and viewing reservation. Further, state information preparation module 2103 obtains identification information of programs being presently viewed and broadcasted contained in service information SI. Program state information preparation module 2103 adds attributes according to program states of programs to the obtained identification information, prepares program state information and transmits the program state information to EPG preparation module 3101 through communication I/F 16 of wireless terminal 15.

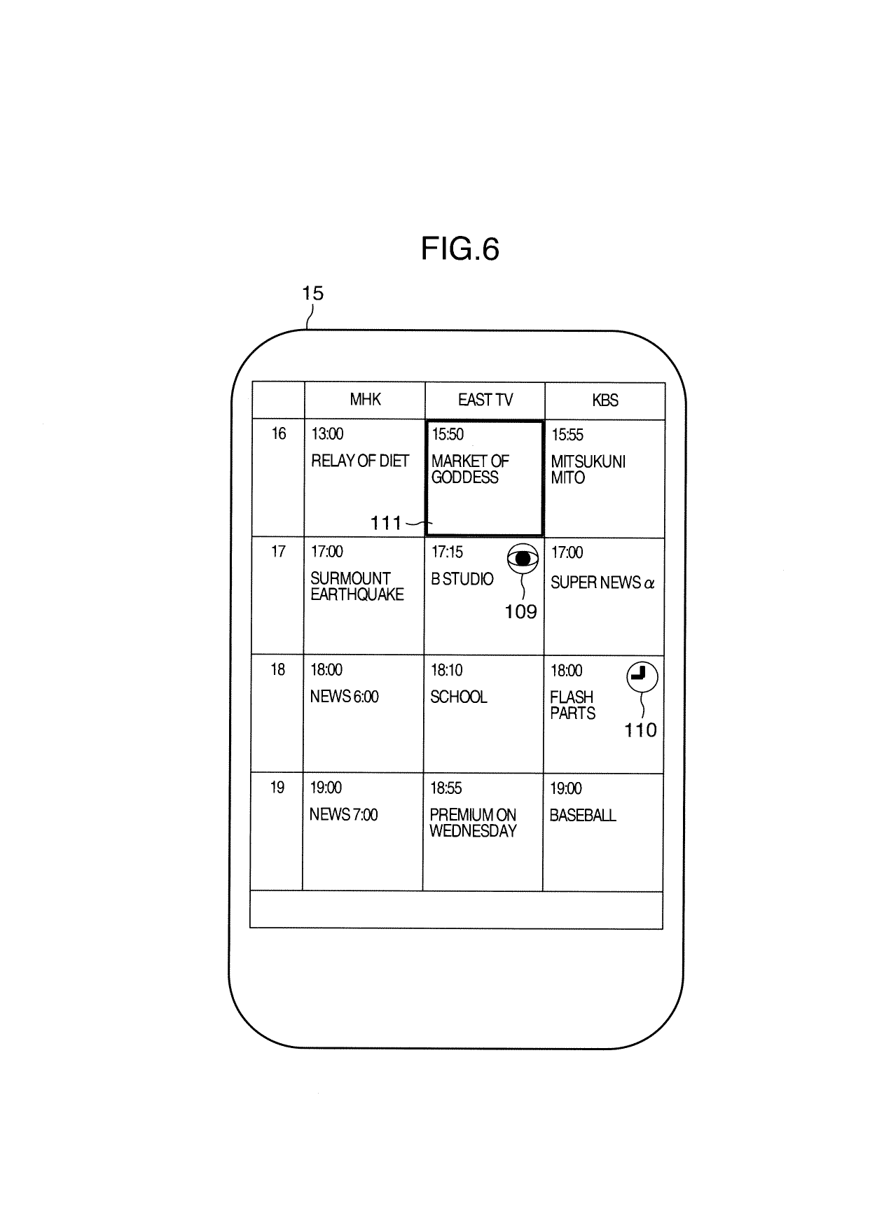

EPG preparation module 3101 receives program state information transmitted from program state information preparation module 2103 (S404) and when identification information described in received program state information is coincident with identification information contained in service information SI separated by signal separator 21 (YES of S405), EPG preparation module 3101 prepares EPG screen in which distinguishable indication inherent to program is displayed in accordance with attribute 104 of program contained in received program state information as shown in FIG. 6 and display the EPG screen on display 19.

The EPG preparation module 2101 also obtains program state information from program state information preparation module 2103 and prepares EPG screen similarly to EPG preparation module 3101 to display the prepared EPG screen on display 11 through superimposition unit 10.

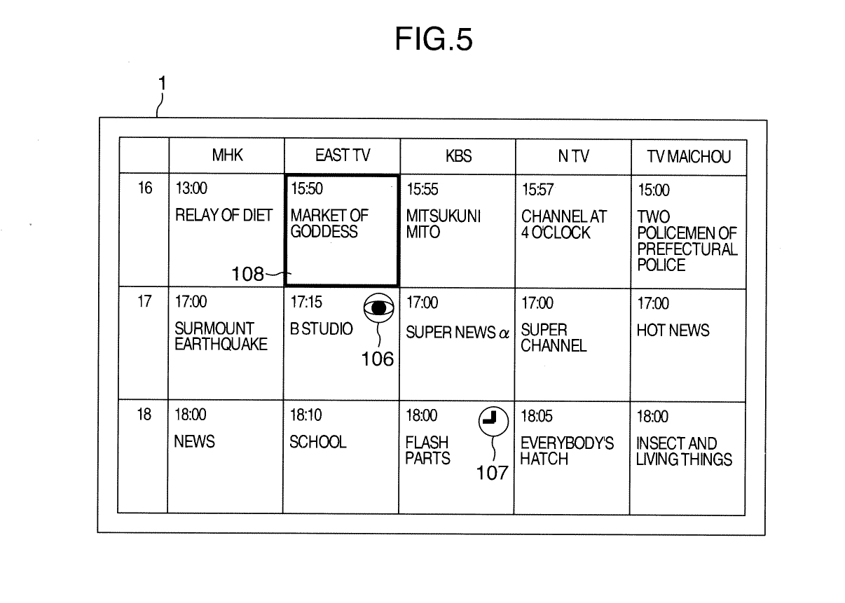

FIG. 5 shows an example of EPG screen displayed on television receiver 1. Mark 106 represents viewing reservation and mark 107 represents recording reservation, so that reservation state of programs displayed in EPG can be recognized. Further, square frame 108 represents program being presently viewed.

Program having attribute of program state information of “0” (being presently viewed) is displayed by 108 and program having attribute of “1” (program reservation (recording)) is displayed by 107, program having attribute of “2” (program reservation (viewing)) being displayed by 106. In the description of the embodiment, FIG. 5 shows for comparison with picture of EPG displayed in wireless terminal 15 and operation and description thereof are omitted.

FIG. 6 shows an example of EPG screen displayed in wireless terminal 15. Marks 109 and 110 correspond to marks 106 and 107 of FIG. 5, respectively. Further, square frame 111 corresponds to square frame 108 of FIG. 5. In the embodiment, the same mark and square frame are used as inherent identification display examples in television receiver 1 and wireless terminal 15 but different mark and square frame may be used. Besides changing shape of mark and square frame, the inside of square frame may be colored or font of program name may be changed, that is, programs having attribute 104 and programs having no attribute 104 may be displayed to be able to be distinguished.

As shown in FIGS. 5 and 6, in EPG displayed in television receiver 1 as shown in FIG. 5 and EPG displayed in wireless terminal 15 as shown in FIG. 6, there are some cases where event information (programs) arranged in a time-series manner for each channel has different arrangement due to difference in display ability of displays 11 and 19, and the numbers of service ID's (channel numbers) and event information (programs) capable of being displayed at the same time are different due to display area of EPG in television receiver 1 and wireless terminal 15.

In FIGS. 6 and 5 of the embodiment, service ID (channel numbers) in horizontal direction and time axis display in vertical direction are 5 channels and 3-hour display in television receiver 1, respectively, and 3 channels and 4-hour display in wireless terminals 15, respectively, although since information of programs which are displayed in TV 1 and wireless terminal 15 and are viewed or reserved is shared, the user can recognize program being viewed or reserved without comparing both of EPG's of television receiver and wireless terminal.

In the foregoing, program state information is prepared in response to request from wireless terminal 15, although program state information may be prepared by program state information preparation module 2103 beforehand and be updated by controller 4 each time program state is changed and program state information may be transmitted when request is received from wireless terminal 15.

Further, only program state information of “being presently viewed” and “being broadcasting” of FIG. 3 updated frequently in particular may be prepared when request is received from wireless terminal 15 and other program state information may be prepared in advance.

Moreover, the date and time that television receiver 1 prepares or updates program state information can be recorded as program state information and when wireless terminal 15 requires to transmit program state information, the program state information can be transmitted together with the date and time of the last update, so that only updated contents of program state information after the last update by wireless terminal 15 can be transmitted to thereby update program state information of wireless terminal 15 to be newest.

Thus, even when wireless terminal 15 frequently issues request, processing of preparing program state information can be omitted and response speed can be increased.

### Embodiment 2

The second embodiment according to the present invention is now described with reference to FIGS. 1, 7 and 8.

In the embodiment, description about different points is emphasized as compared with the first embodiment.

The network to terminal system of the embodiment is the same as that described in FIGS. 1A to 1E of the first embodiment and accordingly description thereof is omitted.

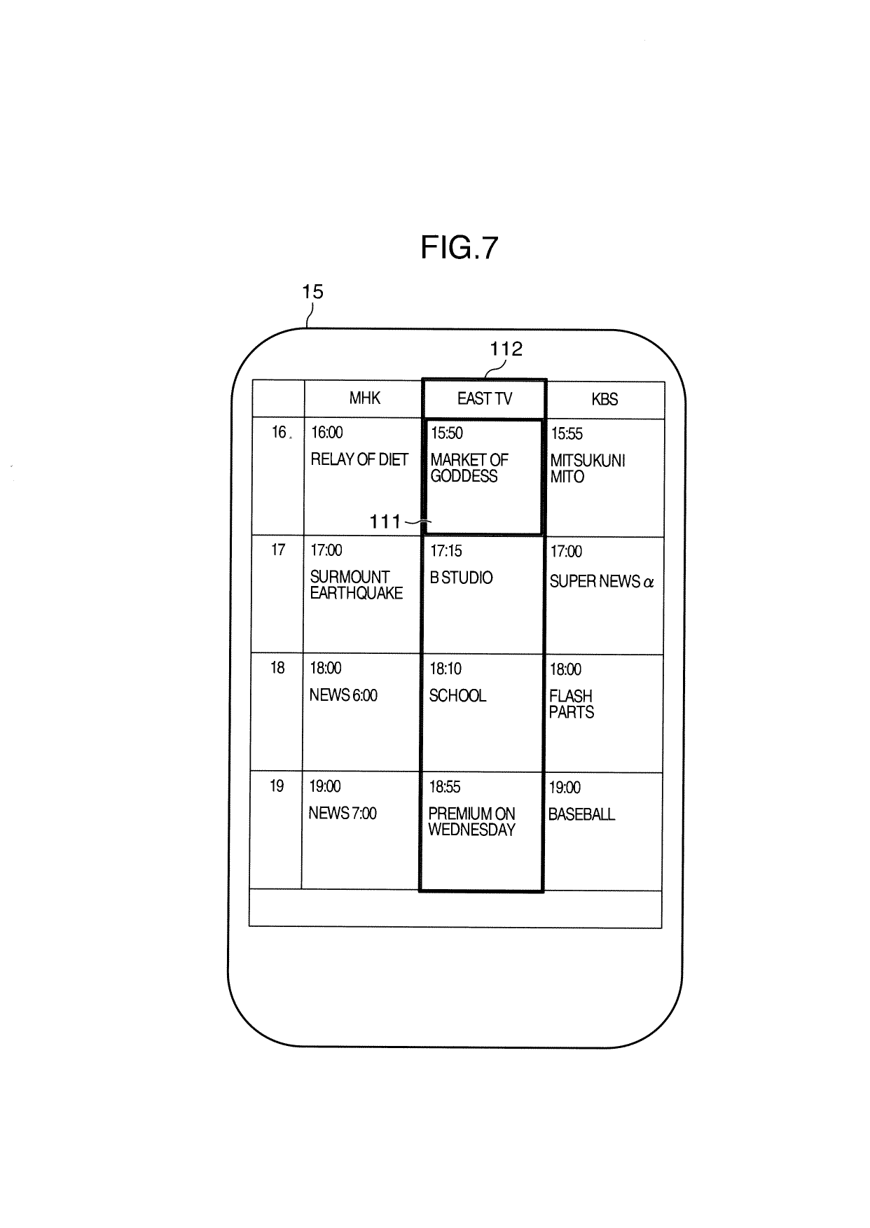

FIG. 7 shows an example of EPG screen displayed in wireless terminal 15 of the embodiment.

When program having attribute 104 of “0” representing “being presently viewed” is contained in program state information received similarly to the first embodiment and identification information of the program contained in program state information is identical with identification information contained in service information separated by signal separator 21, controller 17 of the embodiment controls so that service ID contained in identification information of the program is arranged in the center of display 19 preferentially to other service ID's.

In the embodiment, service ID's are arranged in horizontal direction and events are arranged in vertical direction in time-series manner in EPG displayed on display 19, although service ID (broadcasting station: East TV) containing program 111 (Market of Goddess) being presently viewed is displayed to be arranged in the center of EPG screen preferentially to other service ID's. When even broadcasting stations such as, for example, 4 stations, are arranged horizontally on display 19, the service ID may be arranged near the center so that the service ID is displayed second or third from the left.

As far as the user can easily recognize service ID of program being presently viewed and displayed in EPG, service ID of program being presently viewed may be displayed at left or right end of display 19, for example. Further, service ID of program being presently viewed may be displayed at least on initial screen when operation of displaying EPG screen is performed. However, it is preferable that service ID of program being presently viewed is arranged in predetermined position of screen displayed on display 19 from the viewpoint of ease of user's recognition.

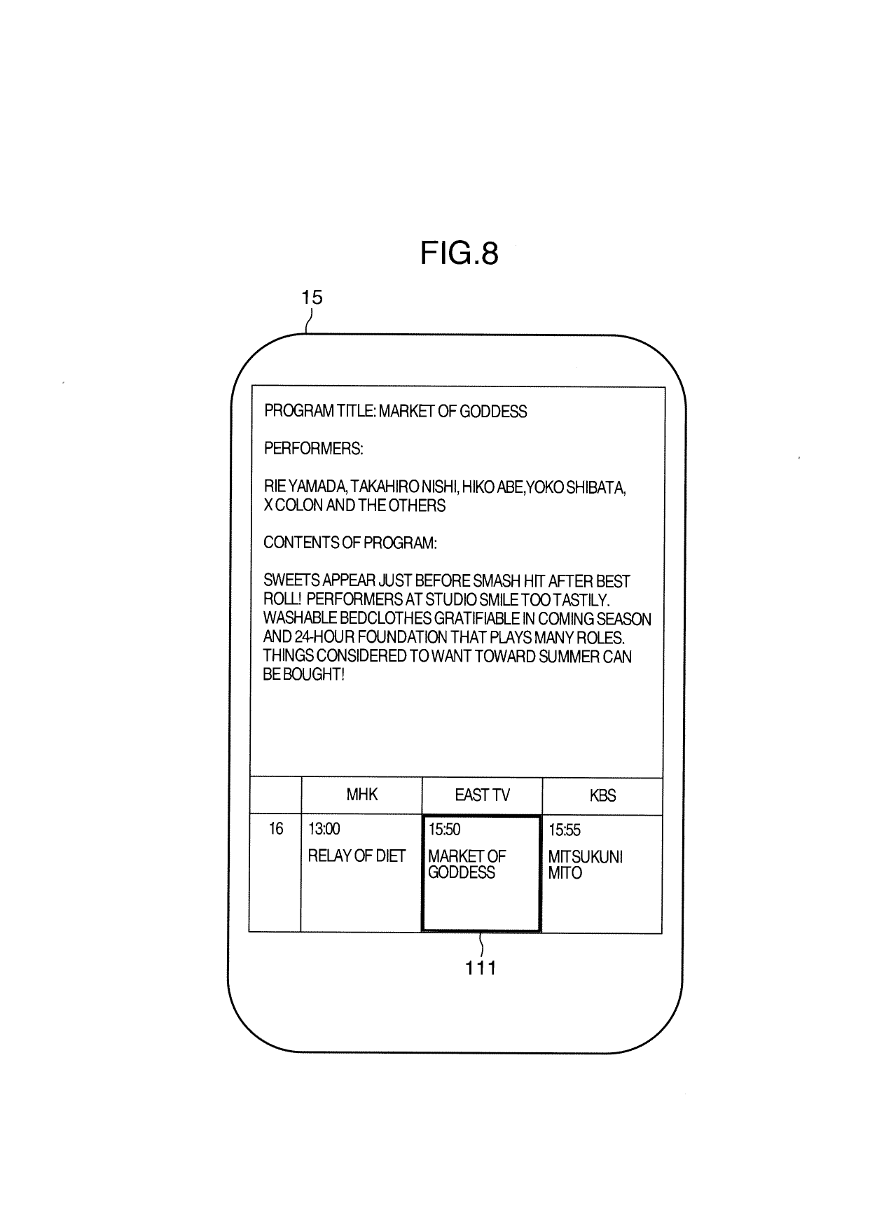

FIG. 8 shows another example of EPG screen displayed on display 19 in the embodiment.

In FIG. 8, details of program being presently wed are displayed as screen displayed initially at the time of start similarly to description of FIG. 7. The details of program can contain performers and contents of program and when service information is obtained through timer 22 from broadcasting waves, partial or all contents of details contained in EIT are displayed. Further, when service information is obtained from external network 14 through communication I/F 16 or mobile communication 31, part or all of information concerning program provided in the form of XML or the like from external network 14 is displayed as details of program.

In the example of FIG. 8, program 111 (Market of Goddess) is being presently viewed and accordingly details of this program are displayed as initial display at start time.

As described above, program being presently viewed on television receiver is preferentially arranged in the center of EPG, so that program information of channel being presently viewed can be confirmed, and programs to be broadcasted after this or programs of adjacent channels can be searched for program that one wishes to view around program or channel being presently viewed.

### Embodiment 3

The third embodiment according to the present invention is now described with reference to FIGS. 6 and 9 to 15.

In the embodiment, description about different points is emphasized as compared with the embodiment.

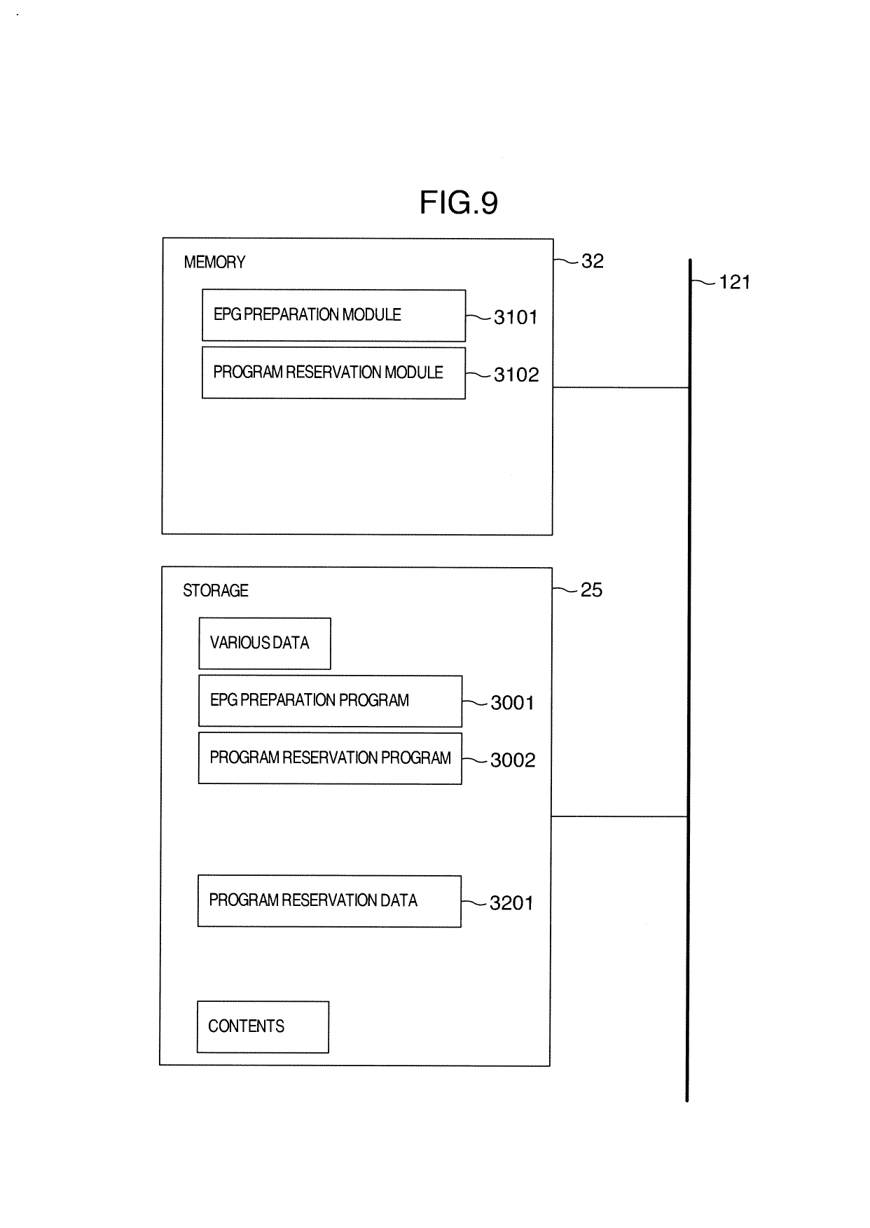

FIG. 9 is a schematic diagram illustrating storage 25 and memory 32 used in wireless terminal 15 of the third embodiment. In FIG. 9, wireless terminal 15 stores program reservation data 3201, EPG preparation program 3001 and program reservation program 3003 in storage 25 and controller 17 loads EPG preparation program 3001 and program reservation program 3002 into memory 32 as EPG preparation module 3101 and program reservation module 3102. EPG preparation program 3001 and program reservation program 3002 may be stored in storage 25 when the product is shipped or may be downloaded through communication I/F 16 or mobile communication I/F 31.

Details of program reservation data 3201 and program reservation module 3102 are the same as program reservation data 2201 and program reservation module 2102 of television receiver 1 in the first embodiment and accordingly description thereof is omitted.

Storage 25 stores reservation information prepared by program reservation module 3102 into program reservation data 3201 in accordance with user's operation received by input unit 20. Further, reservation information of television receiver 1 received through communication I/F 12 and communication I/F 16 is stored in program reservation data 3201.

Moreover, controller 17 can transmit reservation information stored in program reservation data 3201 to controller 4 through communication I/F 16 and communication I/F 12.

Storage 8 stores reservation information prepared by program reservation module 2102 in accordance with user's operation received by input unit 6 in program reservation data 2201. Further, storage 8 has the function of storing or overwriting reservation information of wireless terminal 15 received through communication I/F 16 and communication I/F 12 in program reservation data 2201. In addition, reservation information stored in program reservation data 2201 of storage 8 can be transmitted to controller 17 through communication I/F 12 and communication I/F 16 in response to request of controller 17.

Program reservation module 2102 prepares GUI capable of selecting reservation contents of setting items contained in reservation information in pull-down form check box form or the like and prepares reservation information in accordance with user's operation received by input unit 6.

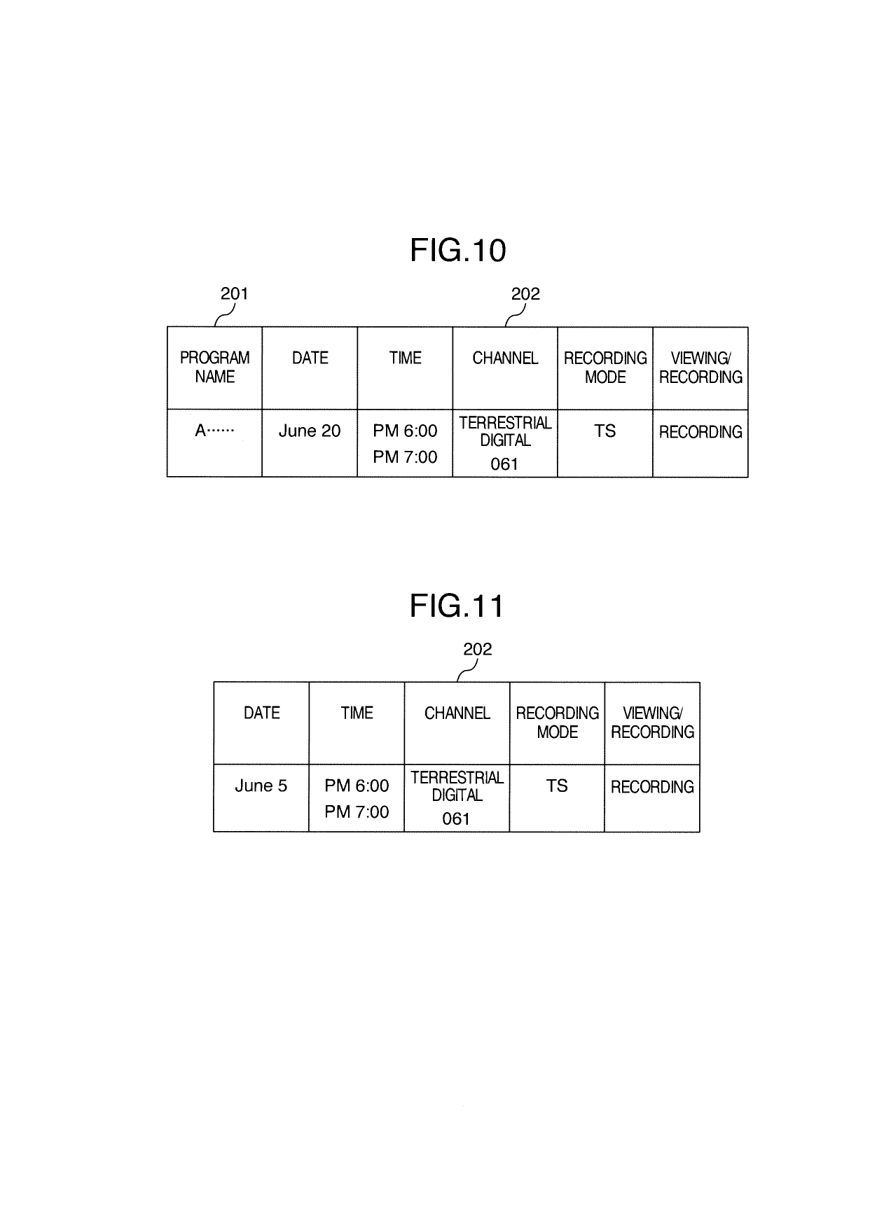

Referring now to FIGS. 10 and 11, data format concerning network terminal system of the embodiment is described.

FIG. 10 shows an example of data format of reservation information.

A shown in FIG. 10, reservation information includes data concerning program name 201, date, time, channel 202, recording mode and viewing/recording. Recording mode data is used only when viewing/recording data is “recording” and represents picture quality of recording such as TS (broadcasting picture quality), TSE (high picture quality of double), TSX4 (high picture quality of quadruple), TSE8 (high picture quality of octuple) and TSX24 (longest time). Further, in addition to the above example, reservation information may contain information representing “every time/every week reservation” representing that recording is made at the same time zone every week, “renewal recording setting” representing whether program to be newly recorded in every time/every week reservation is overwritten on the last recorded program or not, “folder designation” designating folder in which recorded video and audio data are stored and “recording destination” representing recording destination of reserved program for recording when television receiver 1 has plural storage places (HDD, DVD and the like).

FIG. 11 shows a modification example of data format of reservation information.

Data format of reservation information shown in FIG. 11 has no program name 201 as compared with FIG. 10 but information accompanying program except channel 202, date and time such as program name can use program information of EPG screen prepared by EPG preparation module 3101 of wireless terminal 15. Moreover, information (identification information and the like) such as network ID, service ID and event ID which can specify program uniquely and information (reservation state information and the like) concerning setting of specific program may be transmitted.

As described above, the amount of communication data between television receiver 1 and wireless terminal 15 can be reduced and even the case where the amount of program information is increased and detailed information can be displayed can be treated when service information can be obtained from external network or communication network.

Referring now to FIGS. 6, 9 and 12 to 15, the case where EPG of wireless terminal 15 is started by user and program reservation is made is described by way example.

The case where program having program reservation mark added thereto is selected by input unit 20 is described.

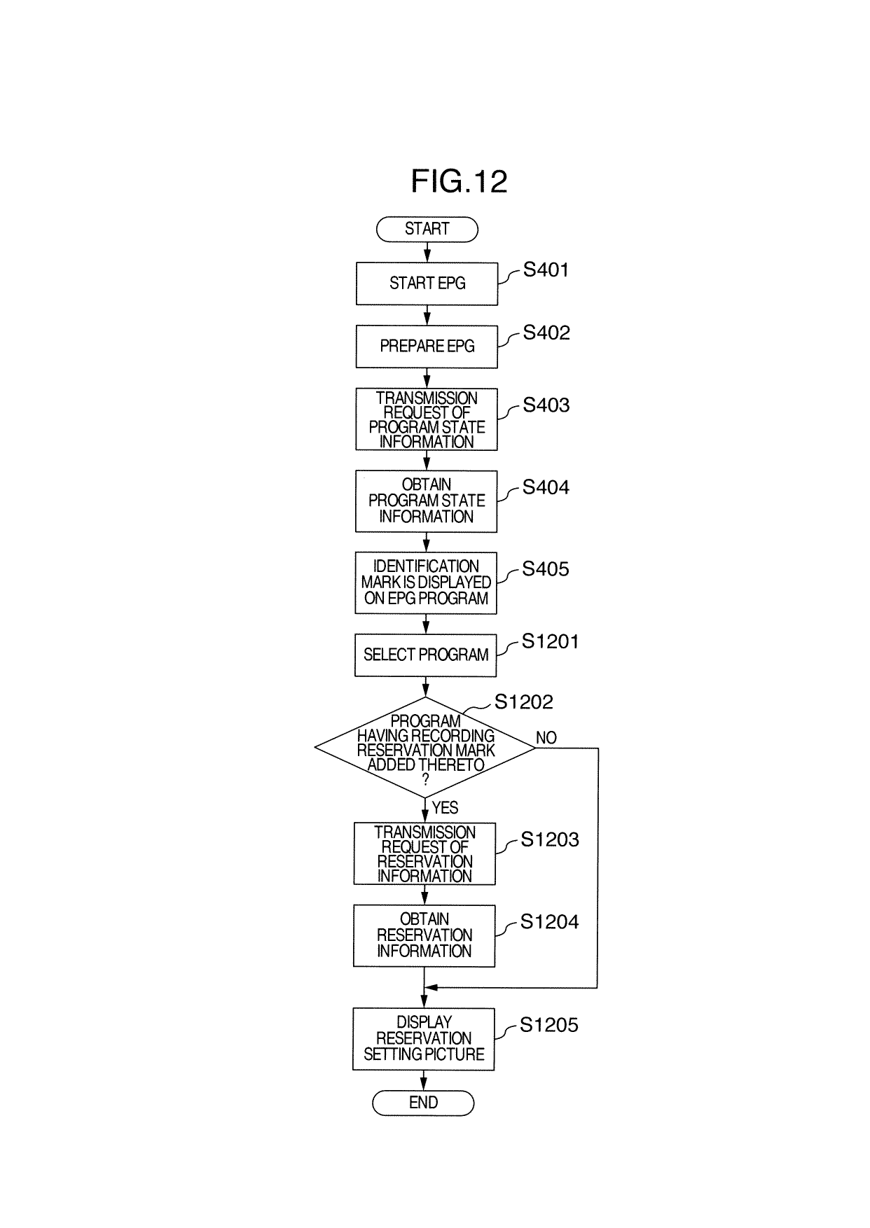

FIG. 12 is a flowchart showing an example of operation sequence at the time that program reservation is made using EPG.

The processing performed until identification mark is displayed on EPG screen (S405) in FIG. 12 is the same as that of FIG. 4 and accordingly description thereof is omitted. After identification mark is displayed on EPG screen, program on EPG screen is selected by input unit 20 (S1201) and when the program has recording reservation mark added thereto (YES of S1202), controller 17 requests controller 4 to transmit reservation information of the selected program (S1203). The transmission request of reservation information contains identification information of the program and the identification information is obtained from EPG preparation module 3101 by controller 17.

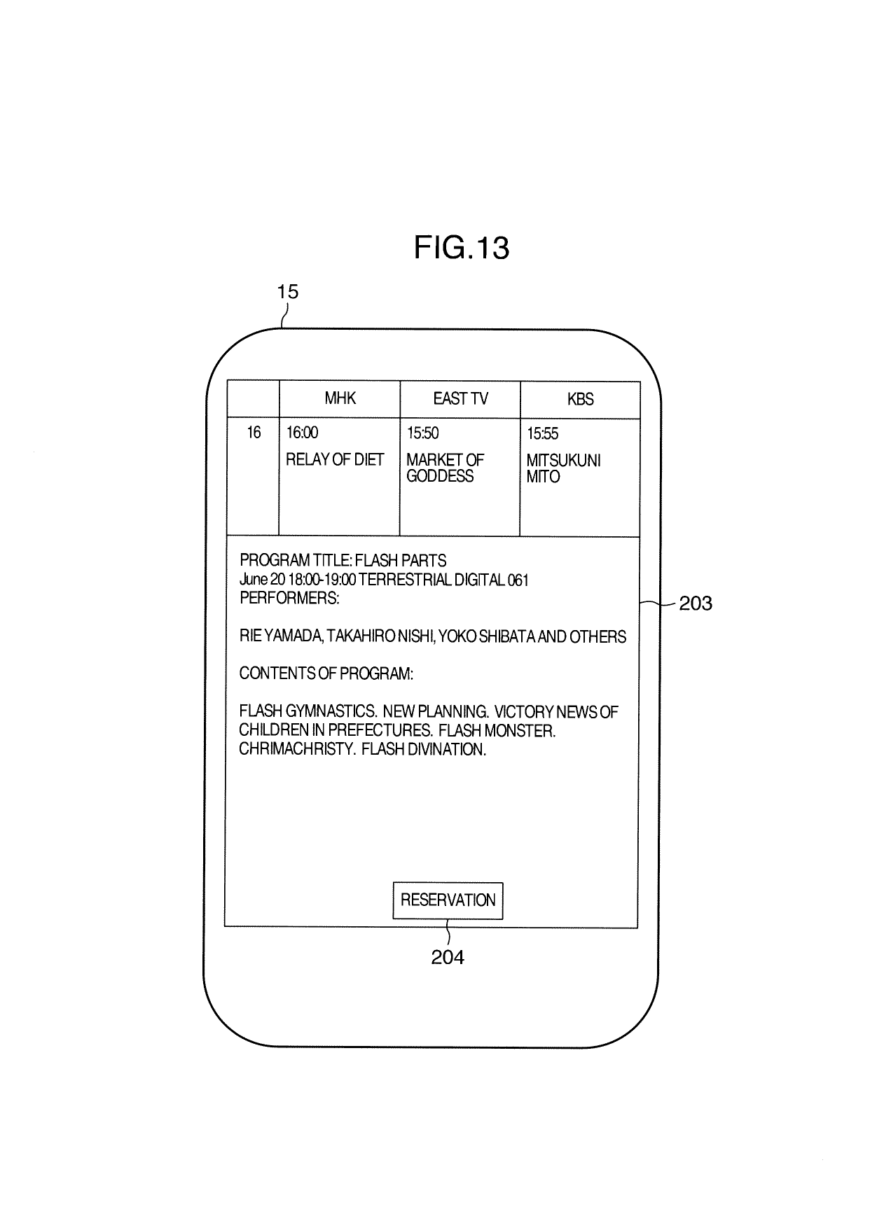

Controller 4 specifies program requested to transmit reservation information from identification information contained in transmission request of reservation information and transmits reservation information of the requested program with reference to program reservation data 2201 to controller 17. Controller 17 receives reservation information transmitted from controller 4 (S1204) and displays reservation setting screen as shown in FIG. 13.

FIG. 13 shows an example of reservation setting screen 203 displayed when program having recording reservation mark 110 is selected in FIG. 6.

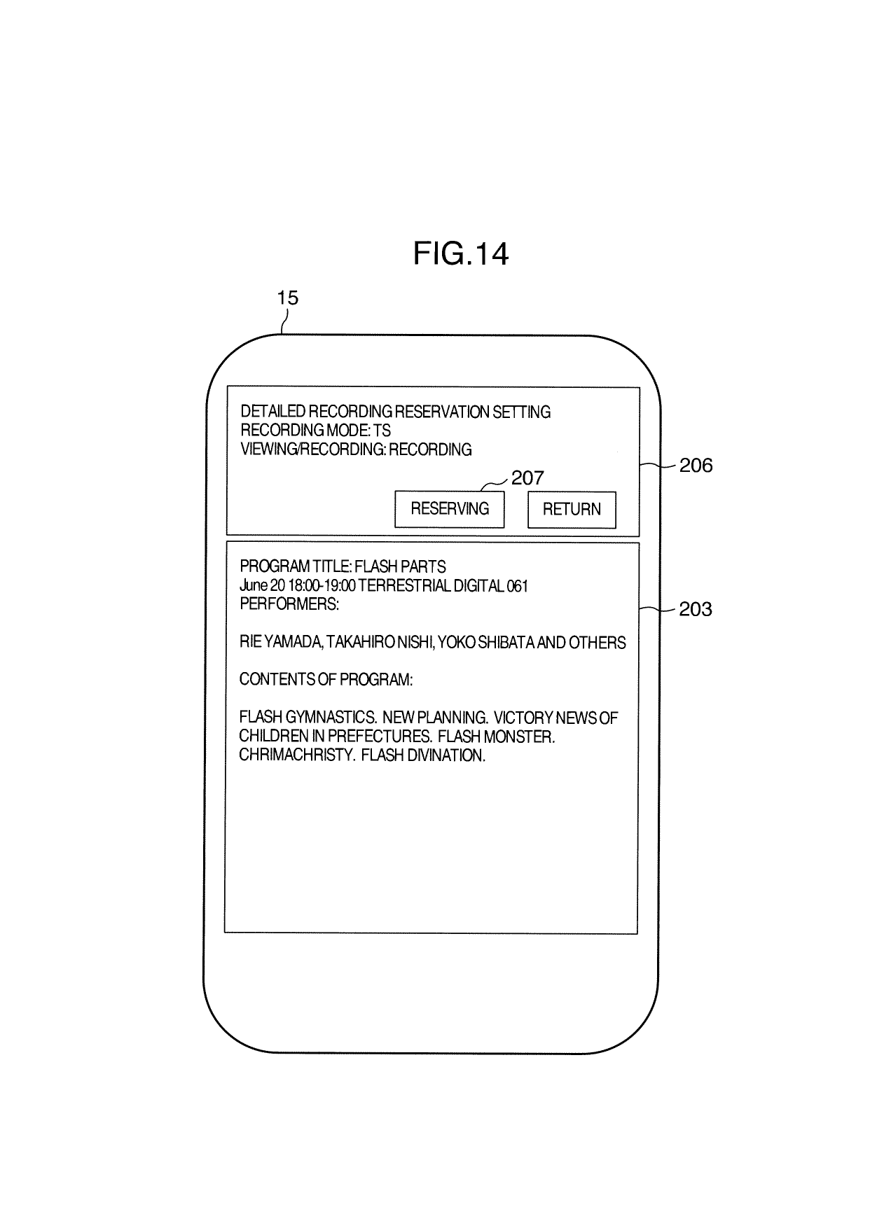

FIG. 14 shows a display example of detailed reservation setting screen 206.

In FIG. 6, when program “flash parts” having recording reservation mark 110 added thereto is selected by input unit 20, reservation setting screen 203 is displayed as shown in FIG. 13. Since program having recording reservation mark has been already set to be recorded in television receiver 1, controller 17 of wireless terminal 15 obtains reservation information from television receiver 1 in accordance with procedure of FIG. 12 and stores it in program reservation data 3201 of storage 23 temporarily.

Program reservation module 3102 obtains detailed program information from service information obtained by EPG preparation module 3101 on the basis of identification information contained in reservation information stored temporarily in program reservation data 3201 and prepares reservation setting screen 203 shown in FIG. 13, Reservation setting screen 203 includes “reservation button” 204 for shifting it to detailed reservation setting screen 206 shown in FIG. 14 together with detailed program information.

In the embodiment, reservation information contains information concerning “recording mode” and “viewing/recording” and accordingly these pieces of information obtained from reservation information are displayed on detailed reservation setting screen 206. These pieces of information can be displayed in the changeable form, for example, such as pull-down form in accordance with input received by input unit 20 of wireless terminal 15. In “recording mode”, picture quality of recording can be selected and in “viewing/recording”, viewing reservation or recording reservation can be selected. Further, when other information is contained in reservation information as described above, program reservation module 3102 displays these pieces of information on detailed reservation setting screen 206 in the changeable form.

“Reserving button” 207 of FIG. 14 is a button for registering reservation information changed after reservation information is changed on detailed reservation setting screen 206 When “reserving button” 207 is selected, program reservation module 3102 reflects the changed contents to reservation information of program reservation data 3201 to be transmitted to controller 4 of television receiver 1 through communication I/F 16. When controller 4 receives updated reservation information, controller 4 overwrites reservation information on program reservation data 2201 in storage 8.

Next, the case where program having no program reservation mark is selected is Described.

When program having no program reservation mark is selected, program reservation module 3102 obtains identification information of the selected program from EPG preparation module 3101 and obtains detailed program information from service information of program identified by the identification information. Program reservation module 3102 displays reservation setting screen 203 and detailed reservation setting screen 206 similarly to the case where program having program reservation mark is selected. However, since reservation information for the program is not prepared, “recording mode” or the like on detailed reservation setting screen is left blank or default is set therein to be displayed in the state that user can change it. When “reserving button” 207 is selected by user, program reservation module 3102 prepares reservation information on the basis of contents set on detailed reservation setting screen 206 to be transmitted to controller 4 of television receiver 1 through communication I/F 16. When controller 4 receives reservation information, controller 4 newly prepares reservation information in program reservation data 2201 of storage 8.

Next, the case where program being presently broadcasted is selected by input unit 20 is described.

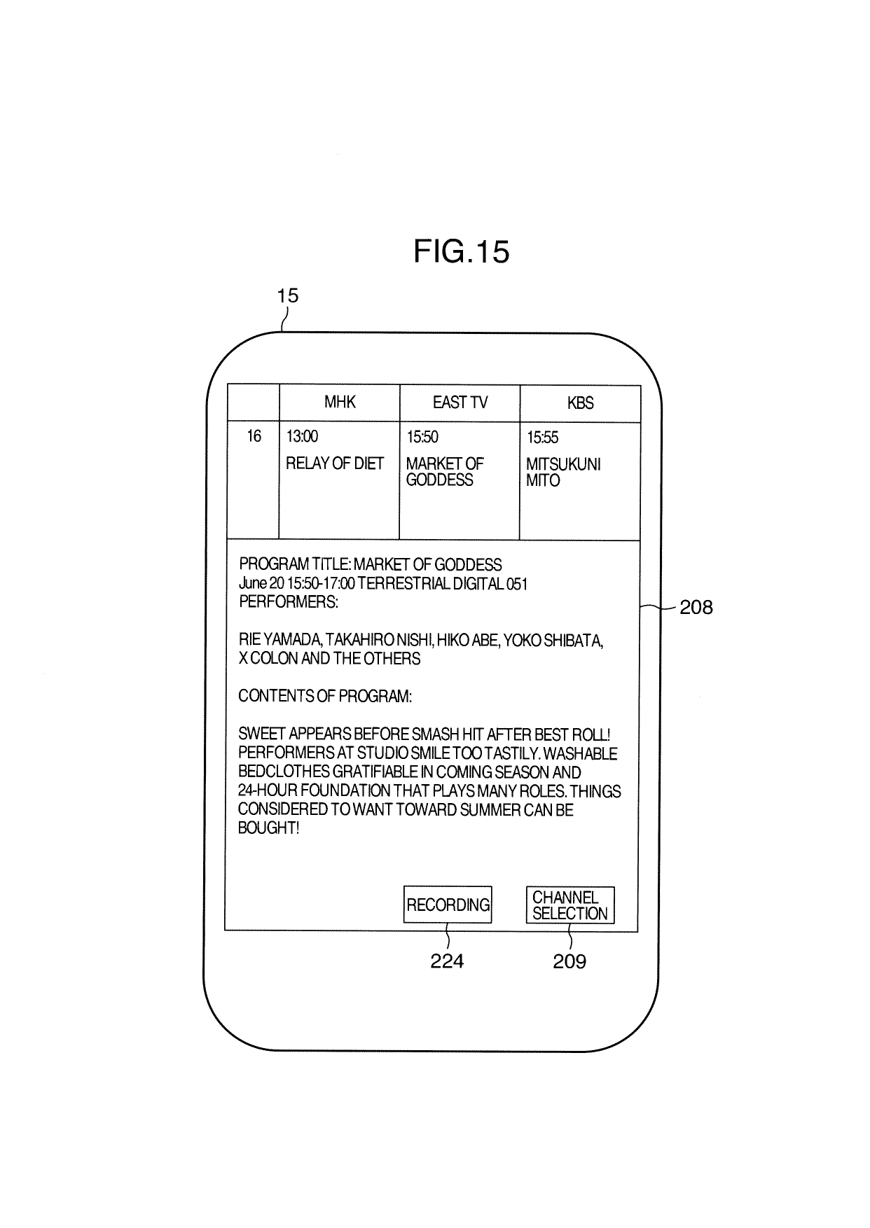

FIG. 15 shows an example of reservation setting screen 208 displayed when program being broadcasted is selected in FIG. 6. This example is different from FIG. 13 in that “recording button” 224 and “channel selection button” 209 are added and “reserving button” 204 is removed.

“Channel selection button” 209 is displayed when program being presently broadcasted is selected. When this button is selected, channel selection information containing information capable of uniquely specifying program being presently selected is transmitted to controller 4 similarly to the reservation information. Controller 4 which has received channel selection information controls timer 2 through channel selection controller 5 to display selected program being broadcasted on display 11.

Channel selection information includes network ID and service ID (channel number), and event ID can be omitted.

“Recording button” 224 is displayed when program being presently broadcasted is selected. When this button is selected, program reservation module 3102 displays screen similar to detailed reservation setting screen 206 and prepares recording information having the same information as reservation information in accordance with contents inputted on displayed screen. The prepared recording information is transmitted to controller 4 of television receiver 1 through communication I/F 16 and controller 4 records program being presently broadcasted in accordance with recording information. Further, when “recording button” 224 is selected, recording information can be prepared using information of “recording mode” and the like set by default to be transmitted. By doing so, program being presently broadcasted can be recorded immediately.

Thus, program reservation in television receiver can be newly registered on the side of wireless terminal and program reservation which has been already set to be recorded can be changed easily. Furthermore, the amount of data communication between wireless terminal and television receiver can be suppressed.

### Embodiment 4

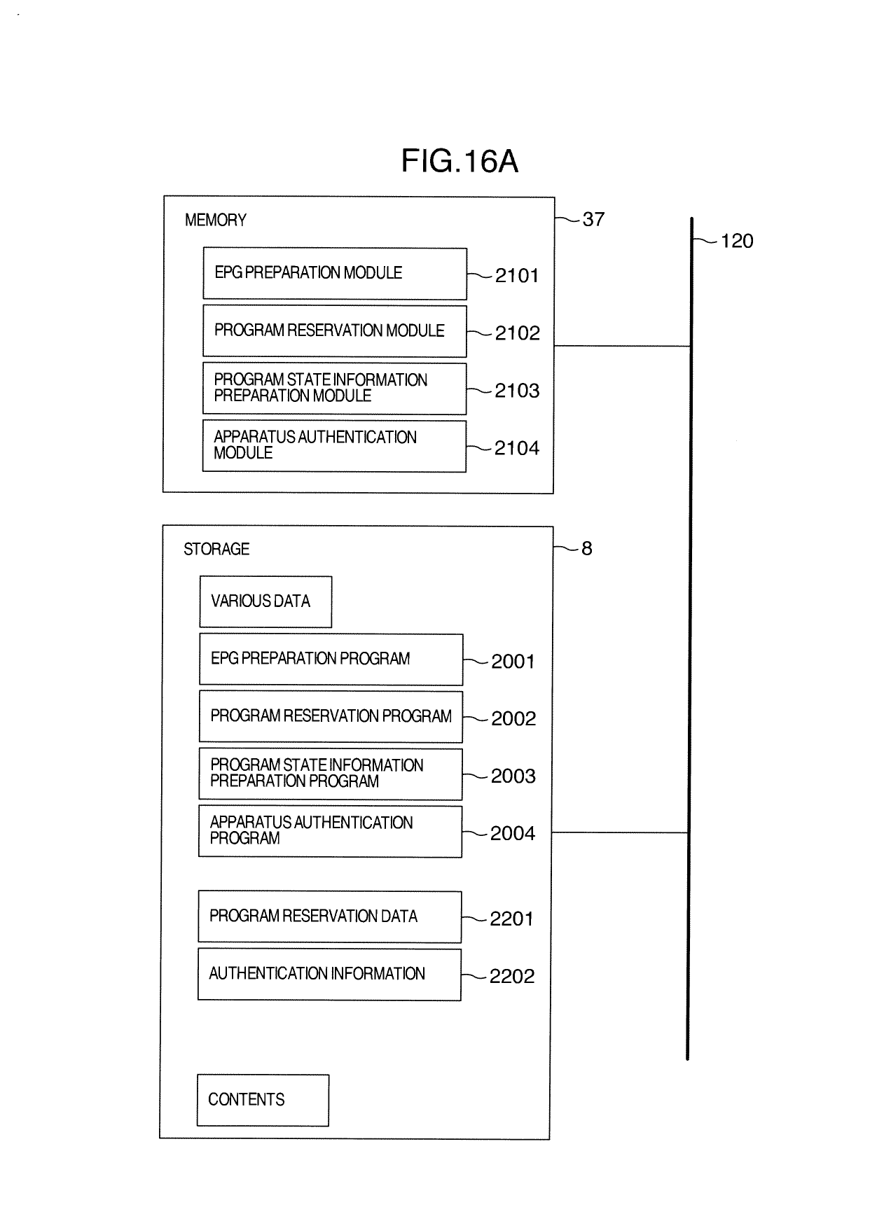

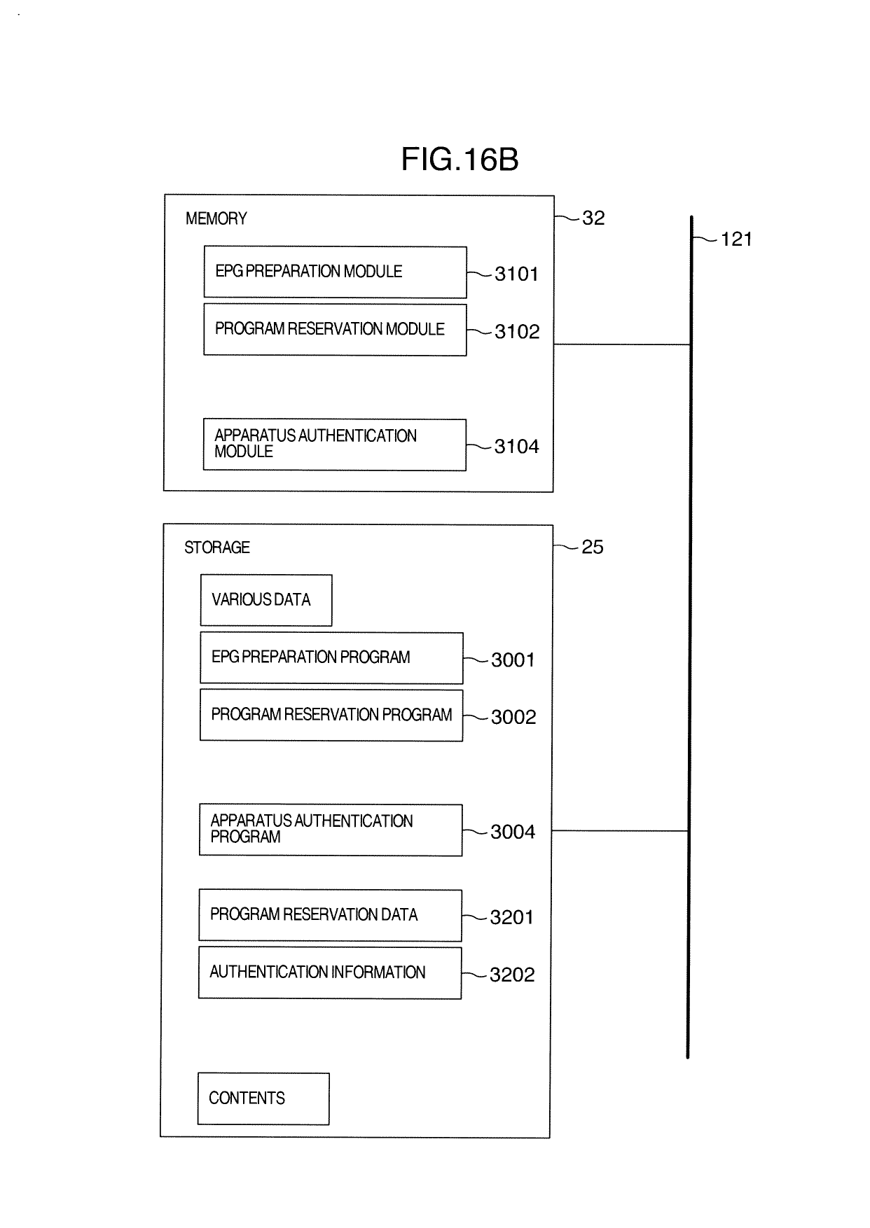

The fourth embodiment according to the present invention is now described reference to FIGS. 16 to 20.

In the embodiment, description about different points is emphasized as compared with the third embodiment.

FIG. 16A is a schematic diagram illustrating storage 8 and memory 37 used in television receiver 1. FIG. 16B is a schematic diagram illustrating storage 25 and memory 32 used in wireless terminal 15. In FIGS. 16A and 16B, television receiver 1 and wireless terminal 15 include authentication data 2202 and 3202 and apparatus authentication programs 2004 and 3004 stored in storages 8 and 25 in addition to constituent elements of FIGS. 1D and 9, respectively, and controllers 4 and 7 load apparatus authentication programs 2004 and 3004 into memories 37 and 32 as apparatus authentication modules 2104 and 3104, respectively. Apparatus authentication programs 2004 and 3004 may be stored in storages 8 and 25, respectively, when the product is shipped or may be downloaded through communication I/F 12 or 16 or mobile communication I/F 31.

In apparatus authentication, authentication information such as user ID and password set in television receiver 1 by user's input using input unit 6 or set in television receiver 1 in advance before shipment of television receiver 1 from factory is stored in authentication data 2202 of storage 8 and apparatus authentication module 2104 can refer to it. Further, the authentication information can be displayed on display 11 by user's operation or can be confirmed on document appended upon purchase of television receiver 1 by user.

Apparatus authentication module 3104 stores authentication information inputted by user's operation received by input unit 20 in authentication data 3202 as authentication information in order to receive authentication from television receiver 1 and transmits the authentication information to apparatus authentication module 2104 through communication I/F 16 or 12.

Apparatus authentication module 2104 compares authentication information stored in authentication data 2202 with authentication information transmitted from apparatus authentication module 3104 and when both are identical, apparatus authentication module 2104 authenticates connection to apparatus authentication module 3104. On the other hand, when both are not identical, apparatus authentication module 2104 does not authenticate connection from apparatus authentication module 3104.

The foregoing is an example of authentication method and, for example, when television receiver 1 and wireless terminal 15 are connected by wireless LAN, authentication and encryption method using SSID (Service Set Identifier) and WEP key or WPS key may be used. Publicly known technique may be used as authentication method and encryption method of information to be transmitted and received when authentication is successful and it is not limited particularly in the embodiment.

Next, the case where program reservation is made from EPG screen displayed on display 19 by means of input unit 20 is described.

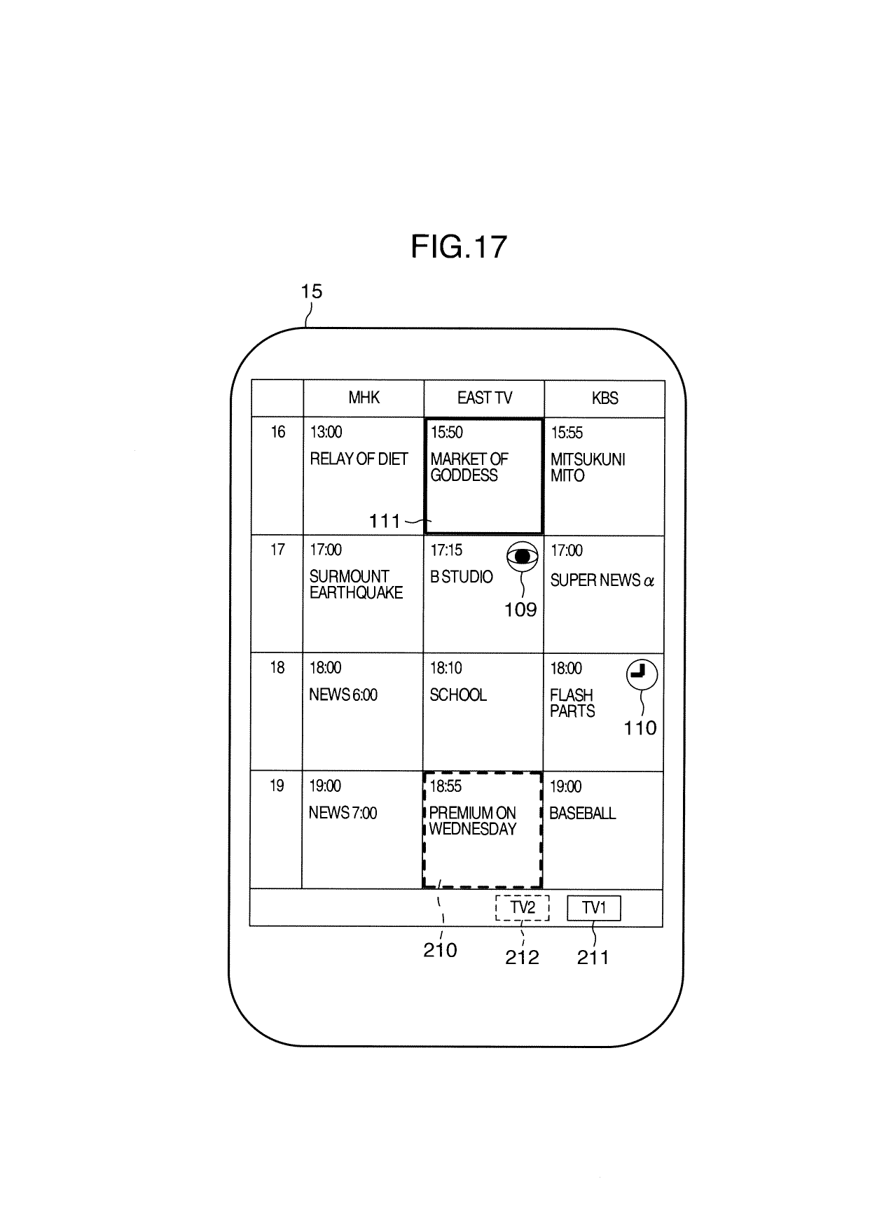

EPG preparation module 3101 prepares EPG screen in accordance with user's operation received by input unit 20 and EPG screen shown in FIG. 17 is displayed on display 19.

FIG. 17 shows an example of EPG screen displayed when program 210 is selected on EPG screen shown in FIG. 6. Program 210 shows selected portion in the embodiment and is enclosed by broken-line square frame.

In the embodiment, EPG preparation module 3101 prepares display marks 211 and 212 of authenticated apparatuses on EPG screen. On EPG screen of FIG. 17, display marks 211 and 212 of authenticated apparatuses indicate that television receivers 1 and 24 are authenticated presently and in the past, respectively. In the embodiment, it is indicated that television receiver 1 is presently authenticated (solid frame) and television receiver 24 was authenticated in the past (broken-line frame) but is not presently authenticated and past records of authentication are also displayed at the same time.

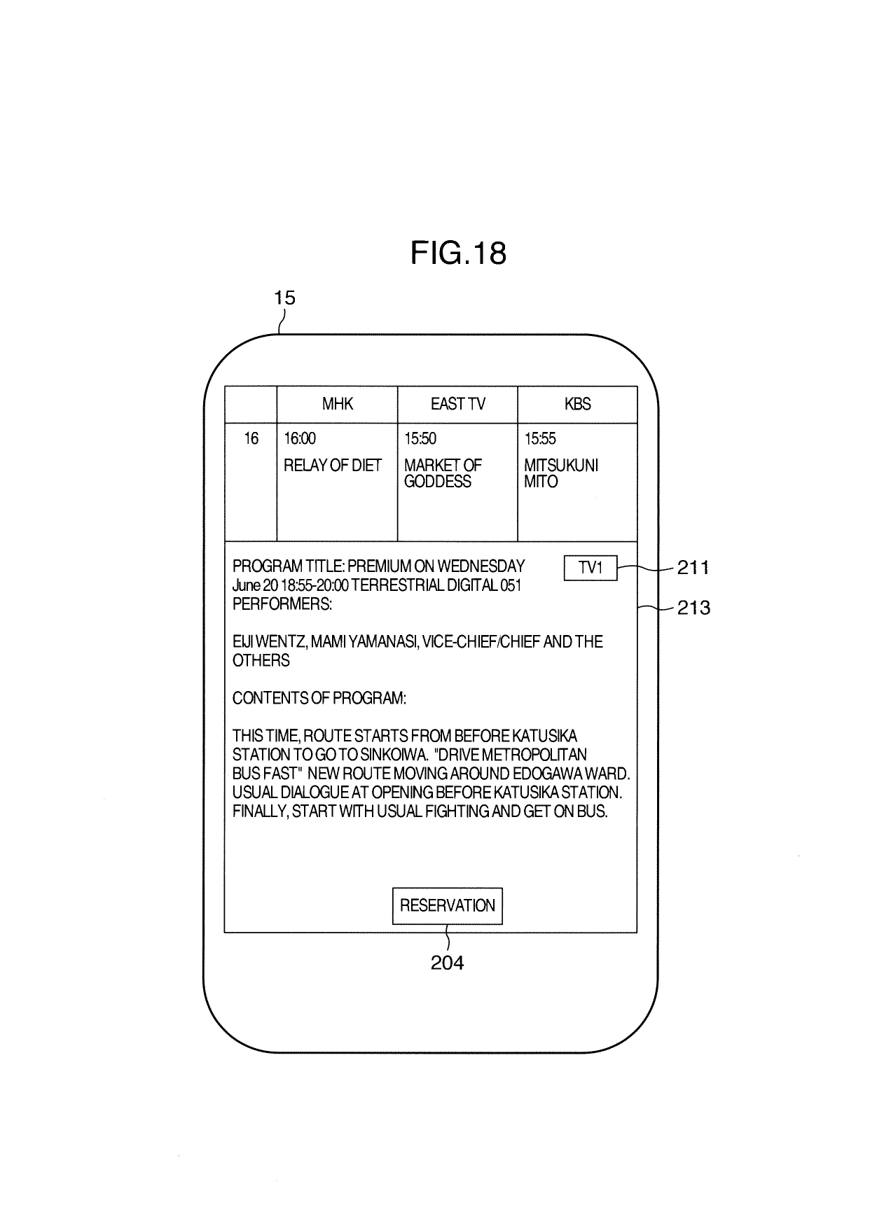

FIG. 18 shows a display example of reservation setting screen 213 of connection apparatus being presently authenticated. In FIG. 17, when program 210 of “Premium on Wednesday” is selected by input unit 20, reservation setting screen 213 is displayed on display 19 as shown in FIG. 18 and program reservation can be made similarly to the third embodiment. Reservation operation is the same as the third embodiment and detailed description thereof is omitted.

Next, the case where television receiver 24 which was connected in the past but is not authenticated presently is selected to make program reservation is described. Such example is supposed to be the case where connection apparatus is located in remote place where Wi-Fi communication cannot be made, the case where connection apparatus is waiting in sleep mode or the case where program information is obtained from communication network outdoors.

In FIG. 17, authentication display 212 of television receiver 24 is displayed by broken-line frame and it is indicated that television receiver 24 was authenticated in the past. Since connection apparatus being presently authenticated is selected in default manner, it is not necessary to select connection apparatus usually, although when program reservation is made to connection apparatus which is not presently authenticated, it is necessary to select connection apparatus before program reservation setting.

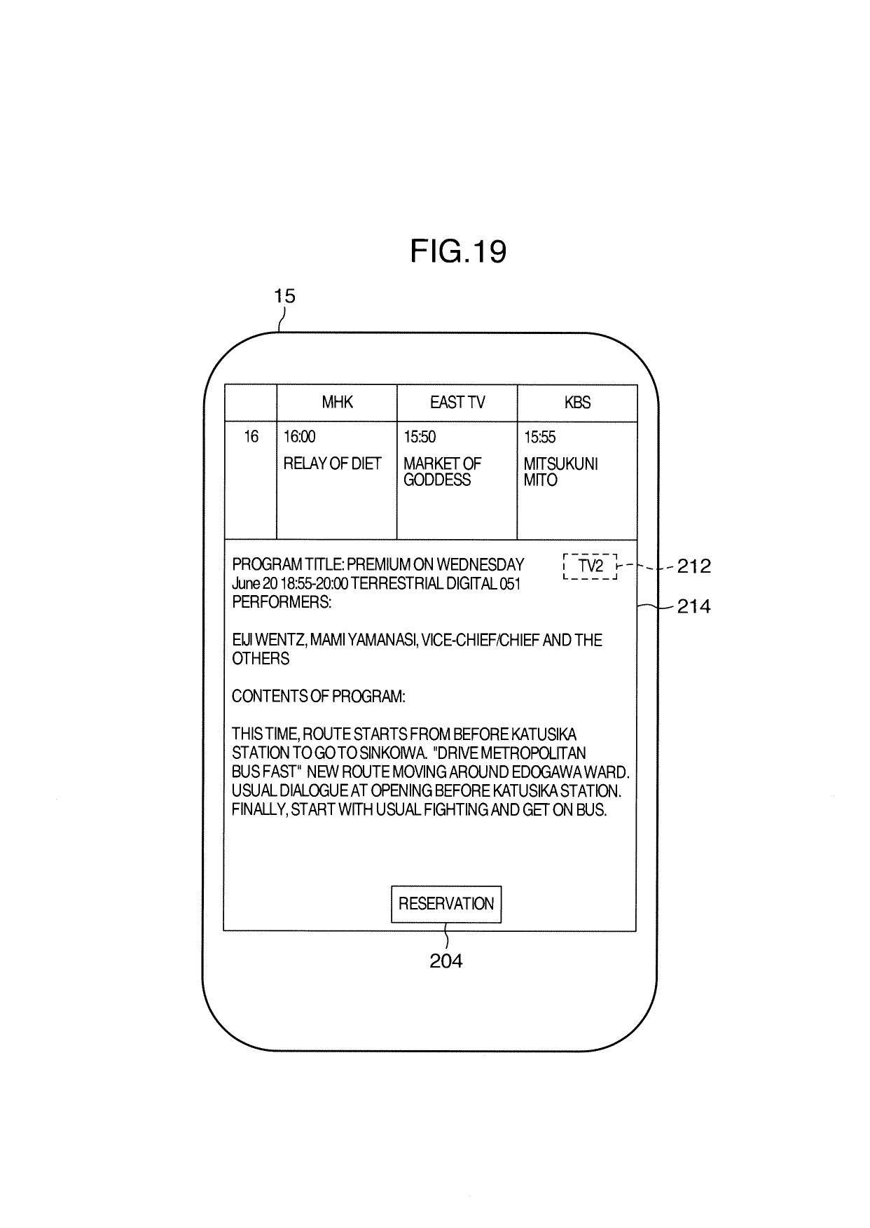

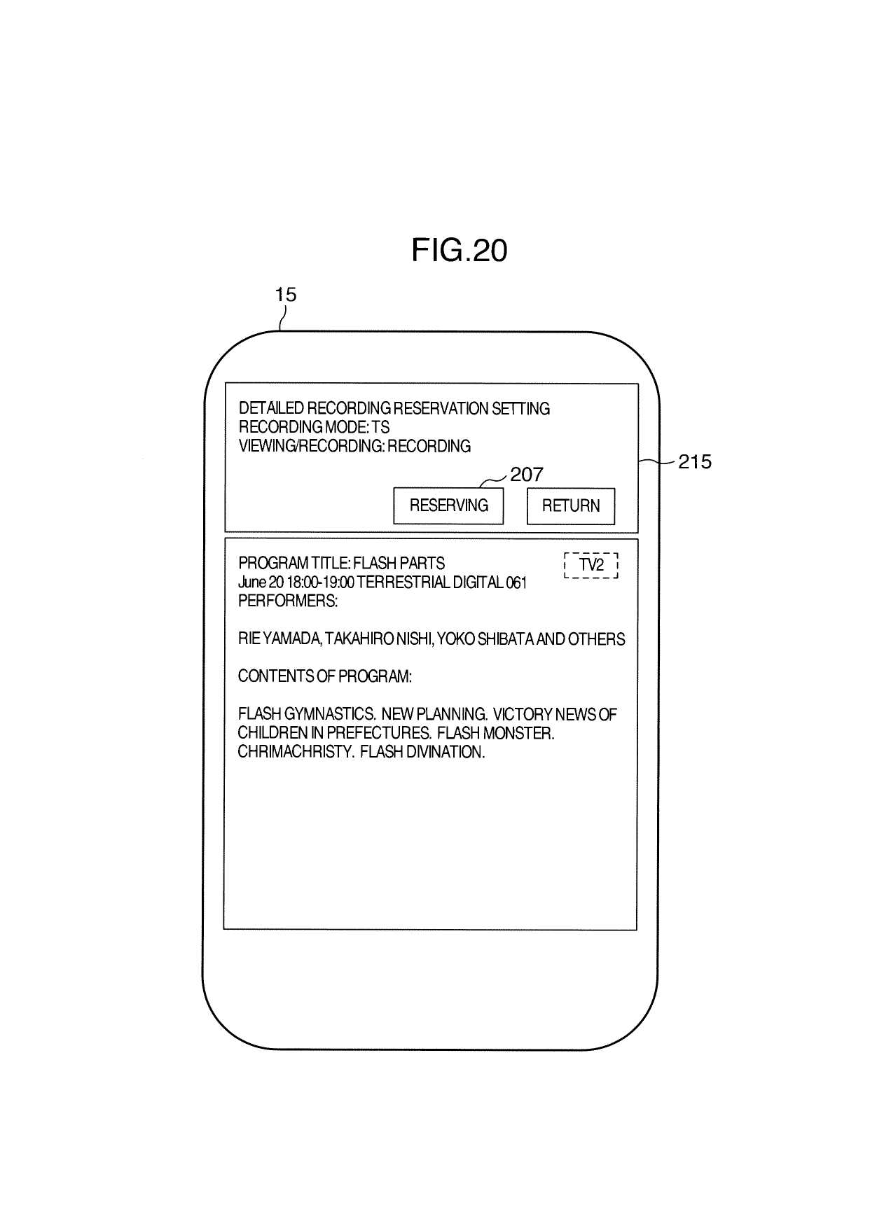

FIG. 19 shows a display example of reservation setting screen 213 of connection apparatus which is not presently authenticated. FIG. 20 shows a display example of detailed reservation setting screen 214 of connection apparatus which is not presently authenticated.

In FIG. 17, when program 210 of “Premium on Wednesday” is selected as described above, reservation setting screen 214 is displayed as shown in FIG. 19 and when “reservation button” 204 is selected, detailed reservation setting screen 215 is displayed as shown in FIG. 20.

When “reserving button” 207 of FIG. 20 is selected, connection apparatus is not authenticated and accordingly reservation information is stored in program reservation data 3201 of storage 25 temporarily and reservation operation is ended.

Thereafter, when wireless terminal 15 enters Wi-Fi communication area from the outside thereof to be able to make access, mutual authentication is made between apparatus authentication modules 2104 and 3104 of television receiver 24 and wireless terminal 15 and program reservation module 3102 transmits reservation information stored in program reservation data 3201 to television receiver 24 through communication I/F 16 to be stored in program reservation data 2201 of television receiver 24 as program reservation information. Further, when start time of reservation information stored in program reservation data 3201 is past time before the present time or reservation information is past information, information of displaying error information on display 19 may be transmitted before setting data is transmitted to television receiver 24.

In the embodiment, description has been made by taking two television receivers connected as an example, although it is not limited that plural television receivers are connected to network. Further, the above description has been made by taking the case where reservation information stored in program reservation data 2201 is transmitted to television receiver 24 automatically when television receiver 24 can be authenticated as an example, although reservation information may be transmitted manually when television receiver 24 can be authenticated. Further, when reservation information is stored in program reservation data 2201 temporarily, temporarily stored state may be displayed by means of icon in order to indicate the state. Moreover, when reservation time designated by reservation information approaches current me while reservation information is not transmitted to television receiver on condition that controller 17 of wireless terminal 15 can understand current time, user can be warned by means of indication on display 19 or the like.

As described above, when program desired to be recorded has been found as in case where program information is obtained from communication network outdoors and program is searched for on EPG screen, setting of the program can be made on that occasion and when it is possible to make connection to network in house after return home, program reservation information can be transferred to television receiver automatically (or manually) without forgetting it.

### Embodiment 5

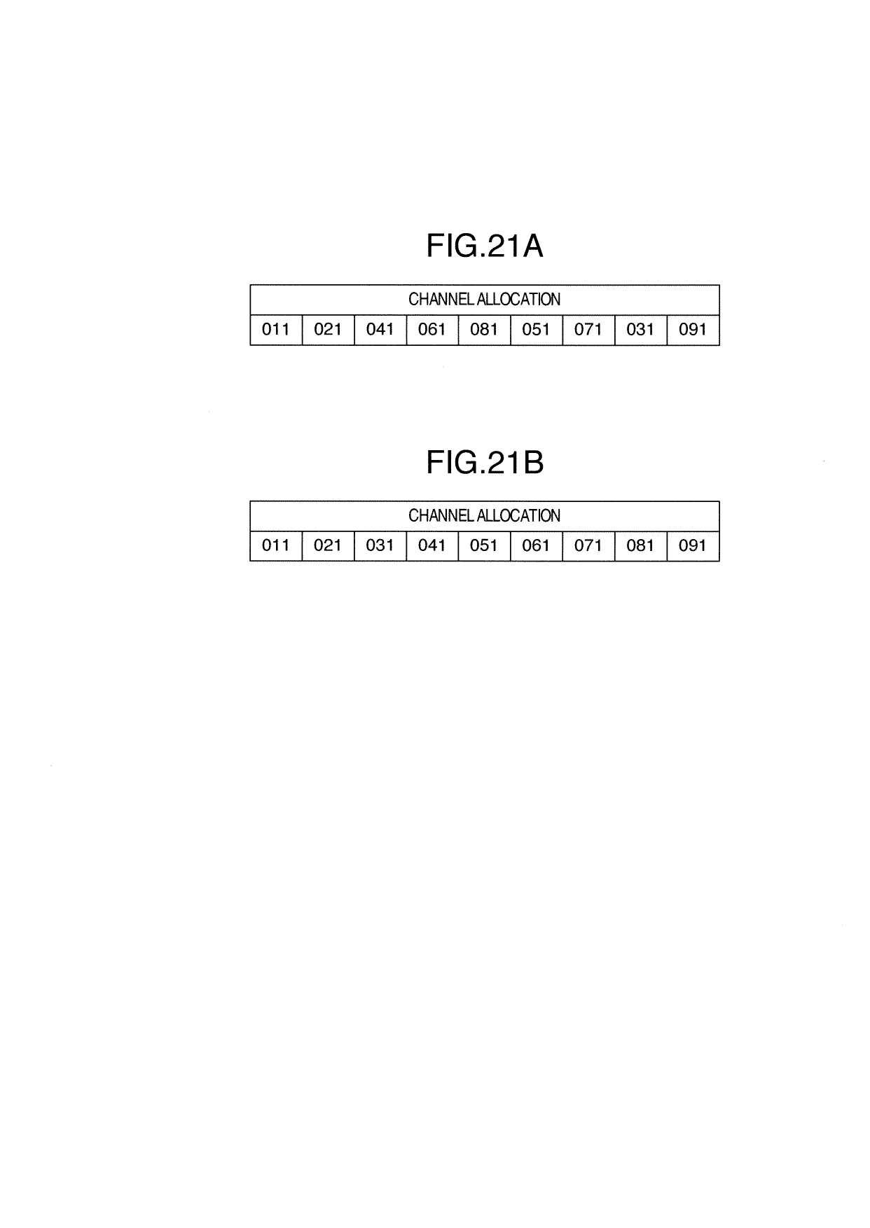

The fifth embodiment according o the present invention is now described reference to FIGS. 1, 21A and 21B.

In the embodiment, description about different points is emphasized as compared with the first embodiment.

Configuration of system, television receiver 1 and wireless terminal 15 in the embodiment is the same as the first embodiment and description thereof is omitted.

FIGS. 21A and 21B show examples of channel allocation information. Channel allocation is made by method of allocating digital broadcasting channels in order of analog broadcasting channels, method of allocating digital broadcasting channels in order of service ID's (channel numbers) of digital broadcasting, method of allocating digital broadcasting channels in order of user's own accord and the like. FIG. 21A shows order of analog broadcasting channels and FIG. 21B shows order of service ID's.

Controller 4 obtains service ID's (channel numbers) and allocation thereof on EPG screen from EPG preparation module 2101 and prepares channel allocation information. Controller 4 transmits the channel allocation information to controller 17 through communication I/F 12, wireless router 13 and communication I/F 16. Controller 17 delivers the received channel allocation information to EPG preparation module 3101 and EPG preparation module 3101 prepares EPG screen using the same channel allocation information as that of EPG of television receiver 1.

FIGS. 5 and 6 of the first embodiment show channel allocation on EPG of television receiver 1 and wireless terminal 15 of the embodiment 5, respectively.

Thus, even when channel allocation is different in television receiver and wireless terminal, channel allocation on EPG screen is the same and accordingly EPG screen can be treated with similar feeling to improve usability.

### Embodiment 6

The sixth embodiment according to the present invention is now described with reference to FIGS. 1A, 9, 13 and 14.

In the embodiment, description about different points is emphasized as compared with the third embodiment.

Configuration of network terminal system, television receiver 1 and wireless terminal 15 in the embodiment is the same as the third embodiment and description thereof is omitted.

In the embodiment, controller 4 transmits EPG data and program state information prepared by EPG preparation module 2101 to controller 17 through communication I/F 16. EPG data is data necessary for preparation of EPG, the data being extracted from information contained in service information and described in the format capable of being interpreted by EPG preparation module 3101 such as XML format and may contain program state information.

Further, EPG preparation module 3101 prepares EPG screen from received EPG data, and EPG screen and program state information are displayed on display 19.

Program reservation module 3102 can store reservation information such as recording reservation made on EPG screen prepared by EPG preparation module 3101 in program reservation data 3202 temporarily and transmit the stored reservation information to program reservation module 2102 through communication I/F 16 and communication I/F 12.

In this manner, by obtaining EPG data from television receiver, program reservation can be made similarly to the third embodiment even when wireless terminal cannot be connected to external network 14 through communication I/F 16 and the like.

### Embodiment 7

The seventh embodiment according to the present invention is now described with reference to FIGS. 17 and 22 to 26.

In the embodiment, description about different points is emphasized as compared with the fourth embodiment.

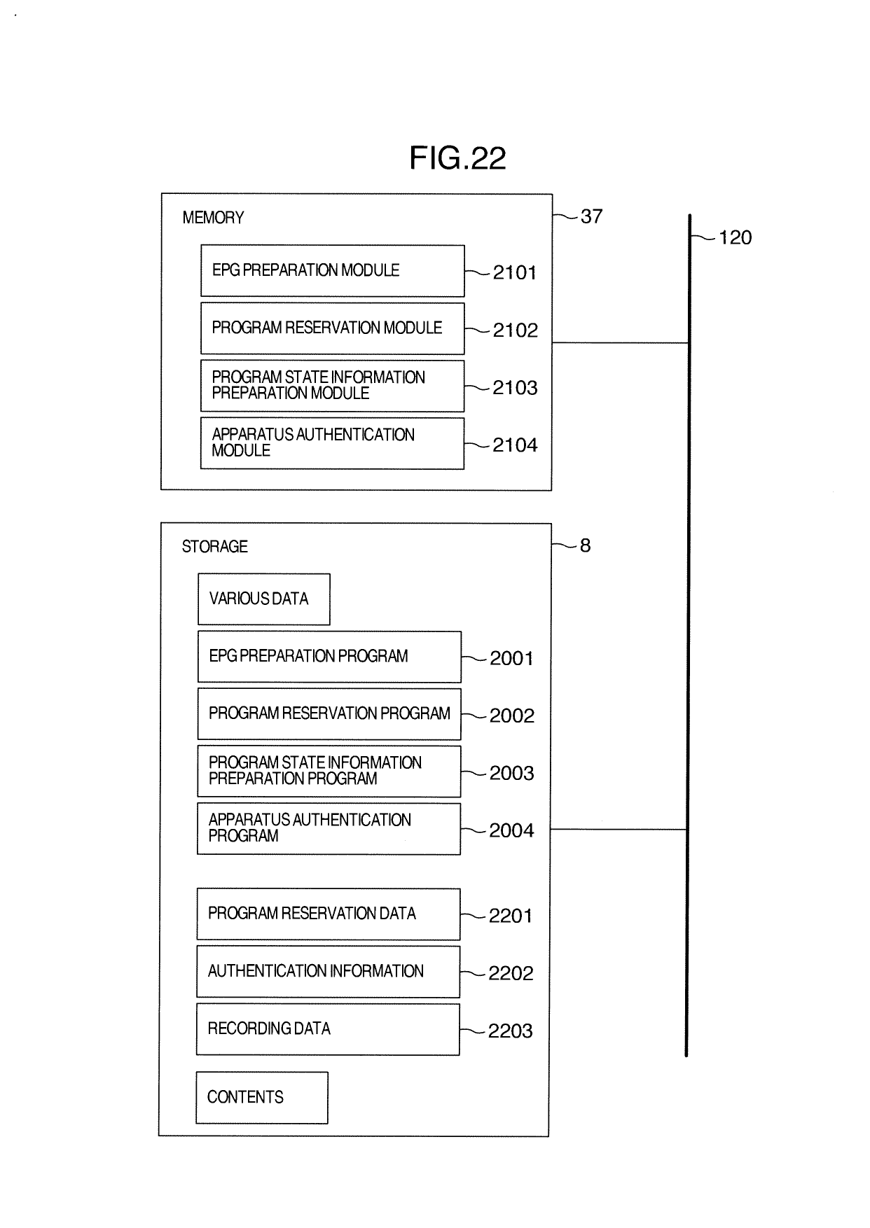

FIG. 22 is a schematic diagram illustrating storage 8 and memory 37 used in television receiver 1. In FIG. 22, television receiver 1 includes recording data 2203 in storage 8 in addition to the fourth embodiment. Recording data 2203 stores therein remaining capacities of storage 8 and external storage connected to digital I/F 44 and anticipatory size in case where reserved program for recording is recorded.

When remaining capacity of storage in which recording data 2203 is stored or remaining capacity of storage obtained by subtracting the anticipatory size from remaining capacity of storage is short or insufficient, when storage is full, when program reservation number is maximum, when there is overlap in reservation time or setting of channel and the like, program reservation module 2102 transmits reservation state information indicating that effect to controller 17.

Next, the case where program reservation is made from program guide displayed on EPG screen of display 19 by input unit 20 is described.

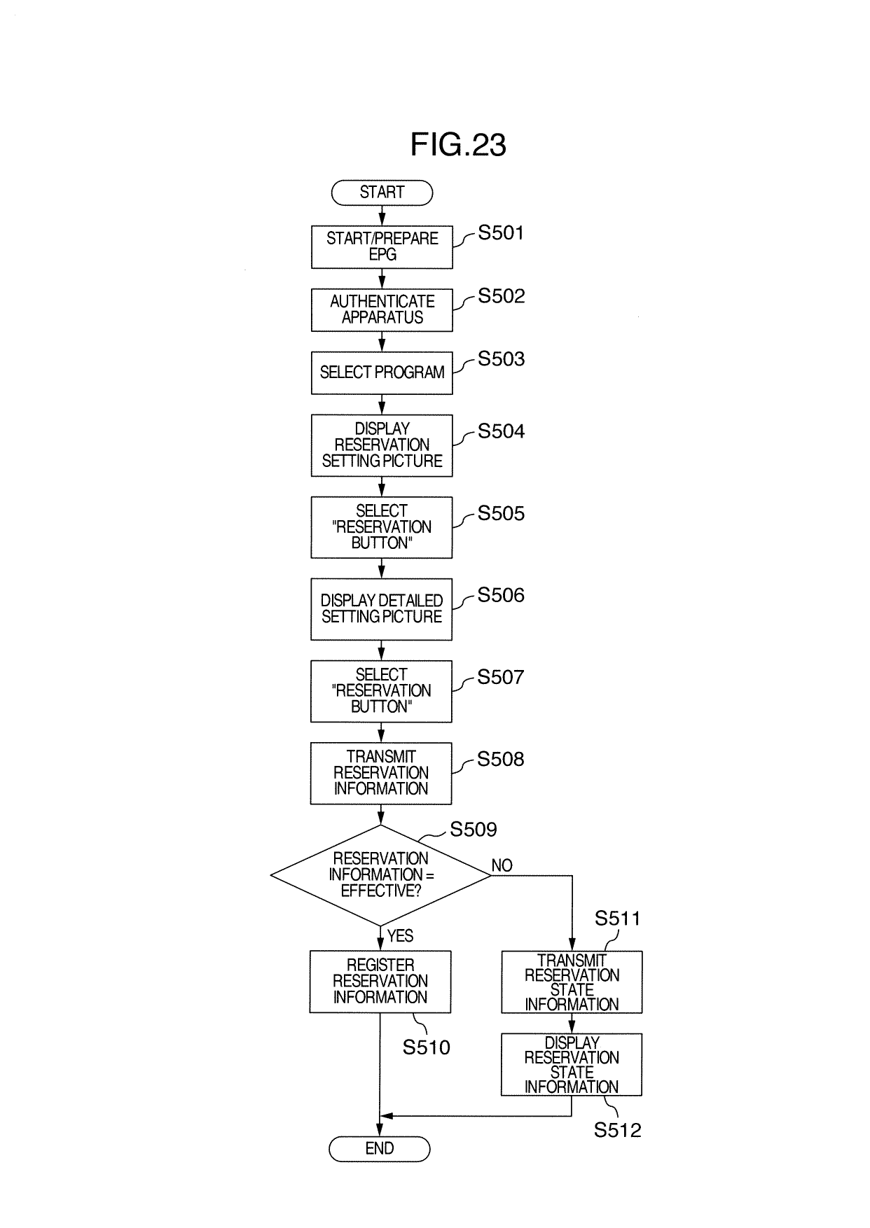

FIG. 23 is a flowchart showing an example of operation sequence in case where program reservation is made from program guide.

EPG preparation module 3101 prepares EPG screen (S501) when EPG preparation module 3101 receives EPG start command from input unit 20.

When authentication information set in advance is inputted to television receiver 1 by input unit 20, authentication information is transmitted to apparatus authentication module 2104 through communication I/F 16 and communication I/F 12 by apparatus authentication module 3104. Apparatus authentication module 2104 authenticates connection to apparatus if authentication module 3104 when authentication information from apparatus authentication module 3104 is correct (S502).

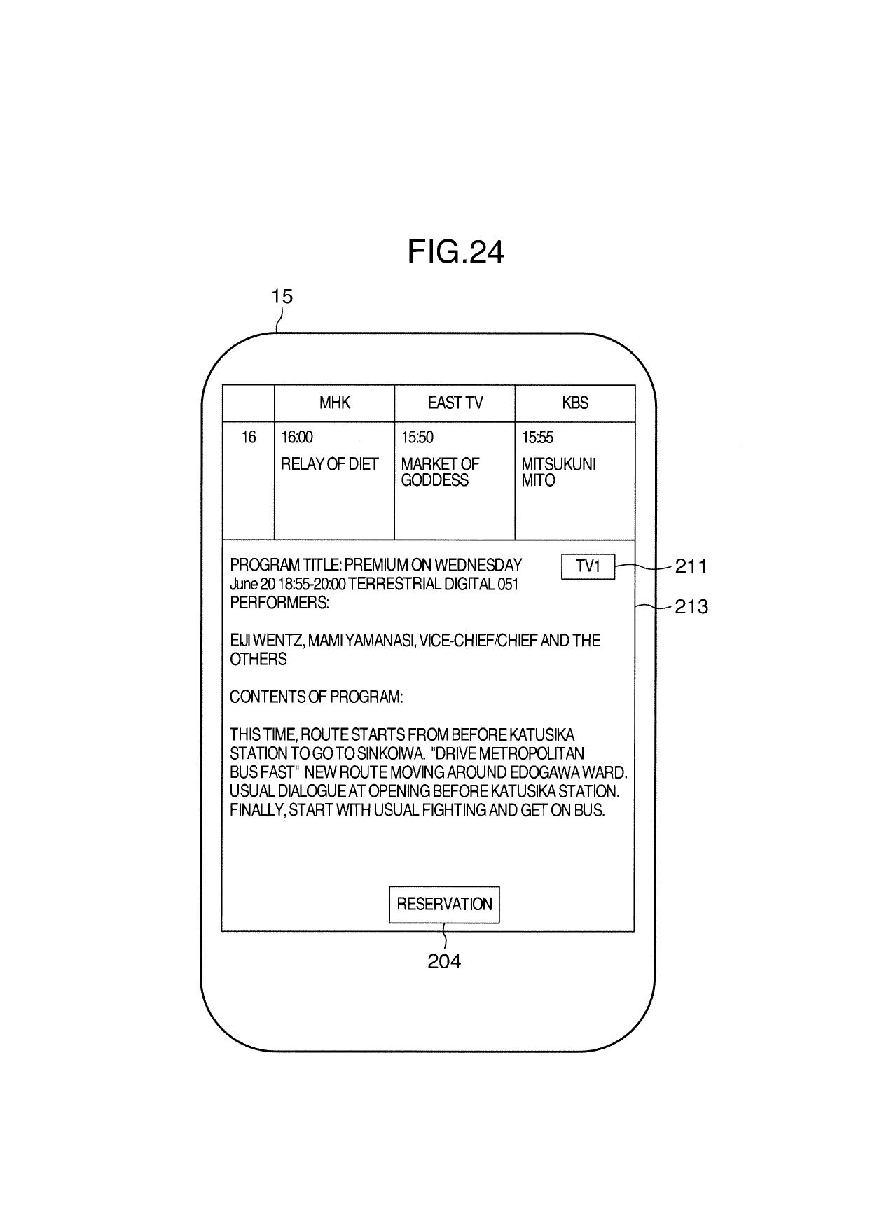

Next, as shown in FIG. 17, when program 210 having no program reservation mark is selected by input unit 20 (S503), program reservation module 3102 prepares reservation information on the basis of program information on EPG screen prepared by EPG preparation module 3101 and prepares reservation setting screen 213 on display 19 as shown in FIG. 24 to be displayed (S504).

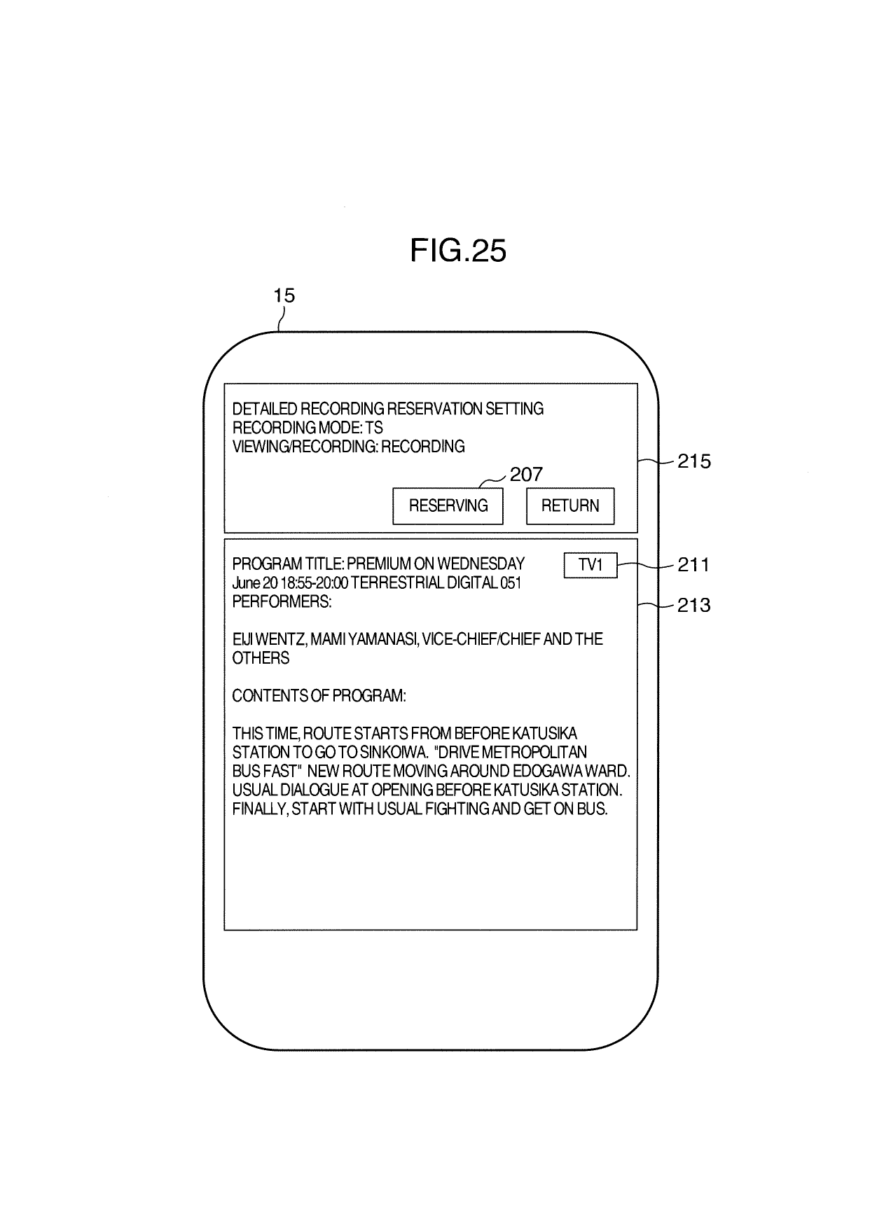

Next, when “reservation button” 204 of FIG. 24 is selected by input unit 20 (S505), detailed reservation setting screen 215 prepared by controller 17 is displayed on display 19 as shown in FIG. 25 (S506).

FIG. 24 shows a display example of reservation setting screen 213. FIG. 25 shows a display example of detailed reservation setting screen 215.

When “reserving button” 207 of FIG. 25 is selected by input unit 20 (S507), program reservation module 3102 transmits reservation setting state as reservation information to controller 4 of television receiver 1 through communication I/F 16 and communication I/F 12 (S508).

Program reservation module 2102 examines necessary data amount of recording data 2203 of storage 8, the number of program reservation, overlap of program reservation and the like in order to judge whether received reservation information is effective or not (S509). When reservation information is effective, reservation information is registered and operation is ended normally (YES of S509 and S510). When reservation information is not effective, reservation state information is transmitted to program reservation module 3102 through communication I/F 12 and communication I/F 16 (NO of S509 and S511). The case where reservation information is not effective contains the case where data amount necessary for recording of program indicated by reservation information exceeds remaining capacity of recording data 2203, the case where program reservation number exceeds predetermined number, the case where two recoding settings are made in the same time zone and the like. Further, when television receiver 1 can make simultaneous recording of plural programs, it is judged not to be effective when the number of recording reservations exceeds simultaneous recordable number.

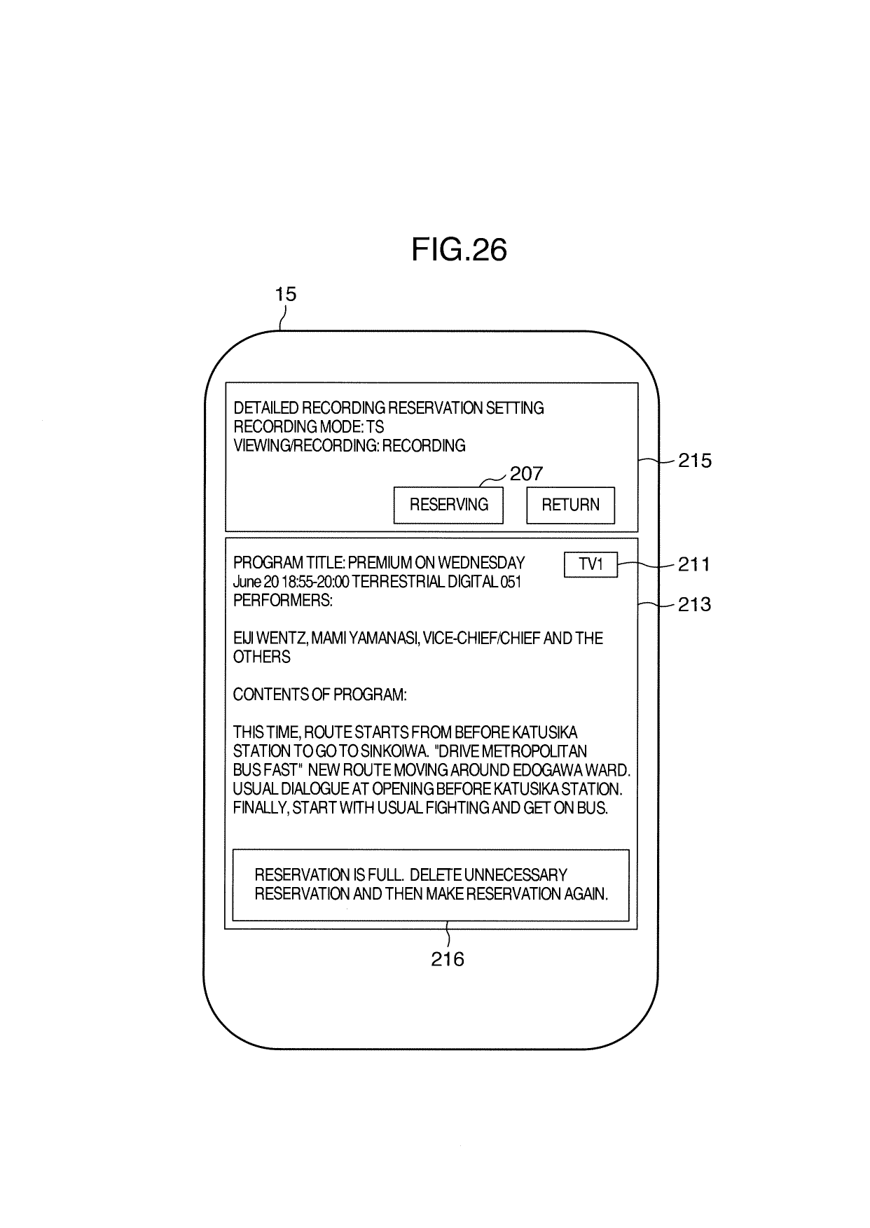

Program reservation module 3102 displays reservation state information indication 216 as shown in FIG. 26 (S512) and notifies message of “reservation setting is full” and the like to user in the case where the number of setting programs for program recording in recording data 2203 is maximum by way of example.

FIG. 26 shows a display example of reservation state information indication 216.

In the embodiment, description has been made to the case where program having no program reservation mark is selected, although even when program having program reservation mark is selected and reservation contents are changed, indication based on reservation state information can be displayed similarly. When program having program reservation mark is selected and reservation contents are not changed, operation in steps S509 to S512 is not necessarily required to be performed because of reservation information decided in television receiver 1 previously.

Further, as a modification example, when the amount of program recording data in recording data 2203 is insufficient for data amount necessary for program recording, recording mode can be automatically set to recording mode having picture quality inferior to currently set recording mode on the basis of reservation state information or indication to the effect that remaining capacity is insufficient can be displayed to ask user whether recording is made in recording mode having inferior picture quality or not. When it is selected that recording is made in recording mode having inferior picture quality, program reservation module 3102 prepares or updates reservation information to be stored in program reservation data 3201 and transmits reservation information to program reservation module 2102.

Furthermore, when viewing reservation or recording reservation is started in television receiver 1, information or the like to the effect that reservation operation is started can be transmitted to wireless terminal 15 in synchronism with start of the reservation, so that state and recording or viewing state of television receiver 1 can be displayed on display 19 of wireless terminal 15.

As described above, even when program reservation is made in wireless terminal, reservation state in television receiver can be understood, so that message can be displayed for user and setting can be changed automatically to thereby make program reservation correctly.

### Embodiment 8

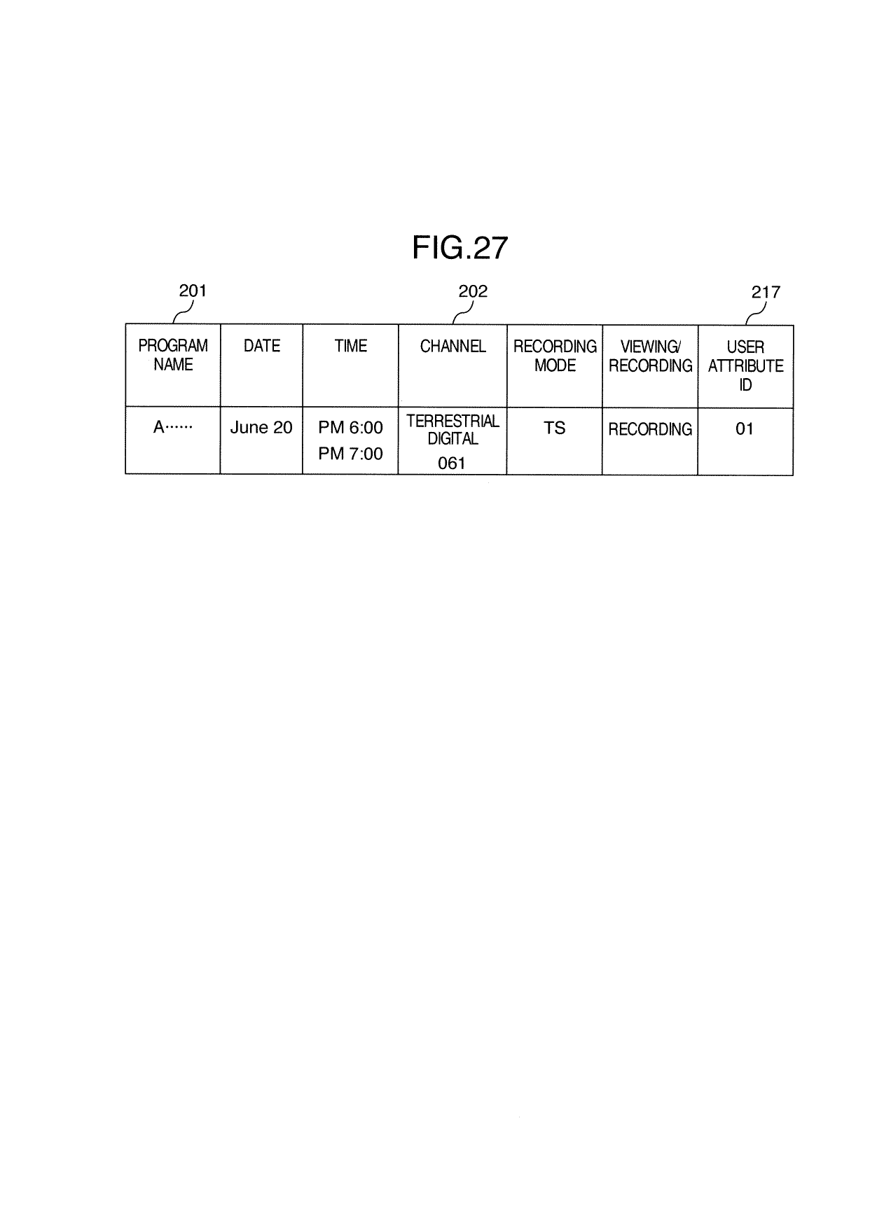

The eighth embodiment according to the present invention is now described with reference to FIGS. 27 to 33.

In the embodiment, description about different points is emphasized as compared with the seventh embodiment.

Configuration of network terminal system, television receiver 1 and wireless terminal 15 in the embodiment is the same as the seventh embodiment and description thereof is omitted.

In the embodiment, apparatus authentication module 3104 has the function of producing user attribute ID inherent to wireless terminal 15 upon apparatus authentication in order to identify user and storing the user attribute ID as personal authentication information in authentication data 3202 of storage 8. Preparation of user attribute ID is made, for example, as follows. Apparatus authentication module 3104 displays input screen of user attribute ID and authentication information on display 19 and transmits input information on input screen by input unit 20 to apparatus authentication module 2104. When apparatus authentication module 2104 confirms that authentication information is correct, user attribute ID is stored in authentication data 2202 as personal authentication information and is referred to if necessary. Further, user attribute ID may be inputted to input screen displayed on display 11 of television receiver 1 by input unit 6 and may be stored in storage 8.

Moreover, when wireless terminal 15 is personal terminal such as portable telephone, information inherent to apparatus such as MAC address can be used as user attribute ID. In this case, in authentication procedure described in the fourth embodiment, when authentication information is transmitted, MAC address can be transmitted to thereby prepare user attribute ID.

Apparatus authentication module 2204 obtains user attribute ID of user presently using wireless terminal 15 by logging-in of user using user attribute ID and password decided freely and when information for recording reservation and like is transmitted, the user attribute ID is transmitted.

Program reservation module 3102 has the function of relating reservation information for program reservation such as recording reservation made on EPG prepared by EPG preparation module 3101 by input unit 20 to user attribute ID prepared by apparatus authentication module 3104 to be stored in program reservation data 3201 temporarily.

Referring now to FIG. 27, data format related to network terminal system of the embodiment is described. FIG. 27 shows an example of data format of reservation information.

As shown in FIG. 27, reservation information includes program name 201, date, time, channel 202, recording mode, viewing/recording data and user attribute ID 217, and user attribute ID 217 is added to data format shown in FIG. 10 of the third embodiment. Further, user attribute ID 217 is related to other reservation information to be stored in recording data 2203 or program reservation data 3201 temporarily.

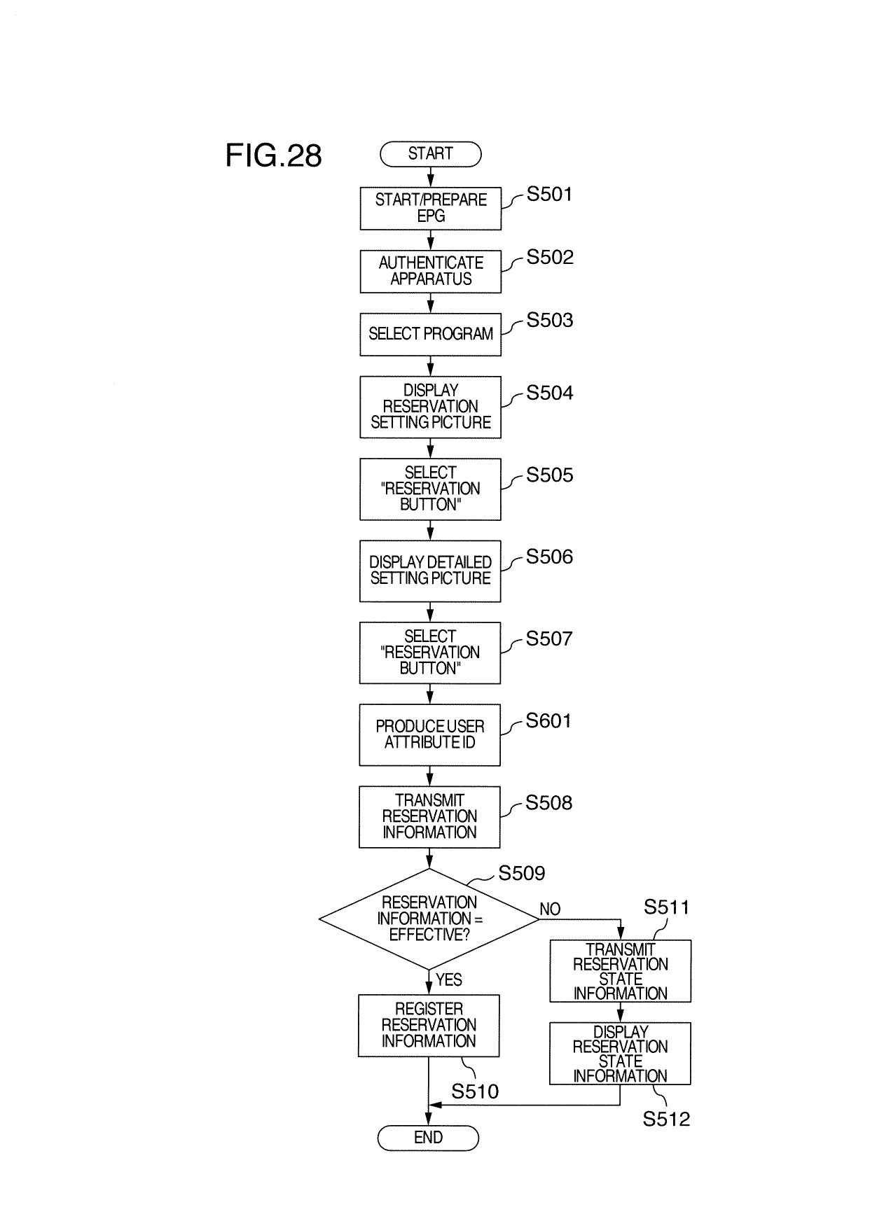

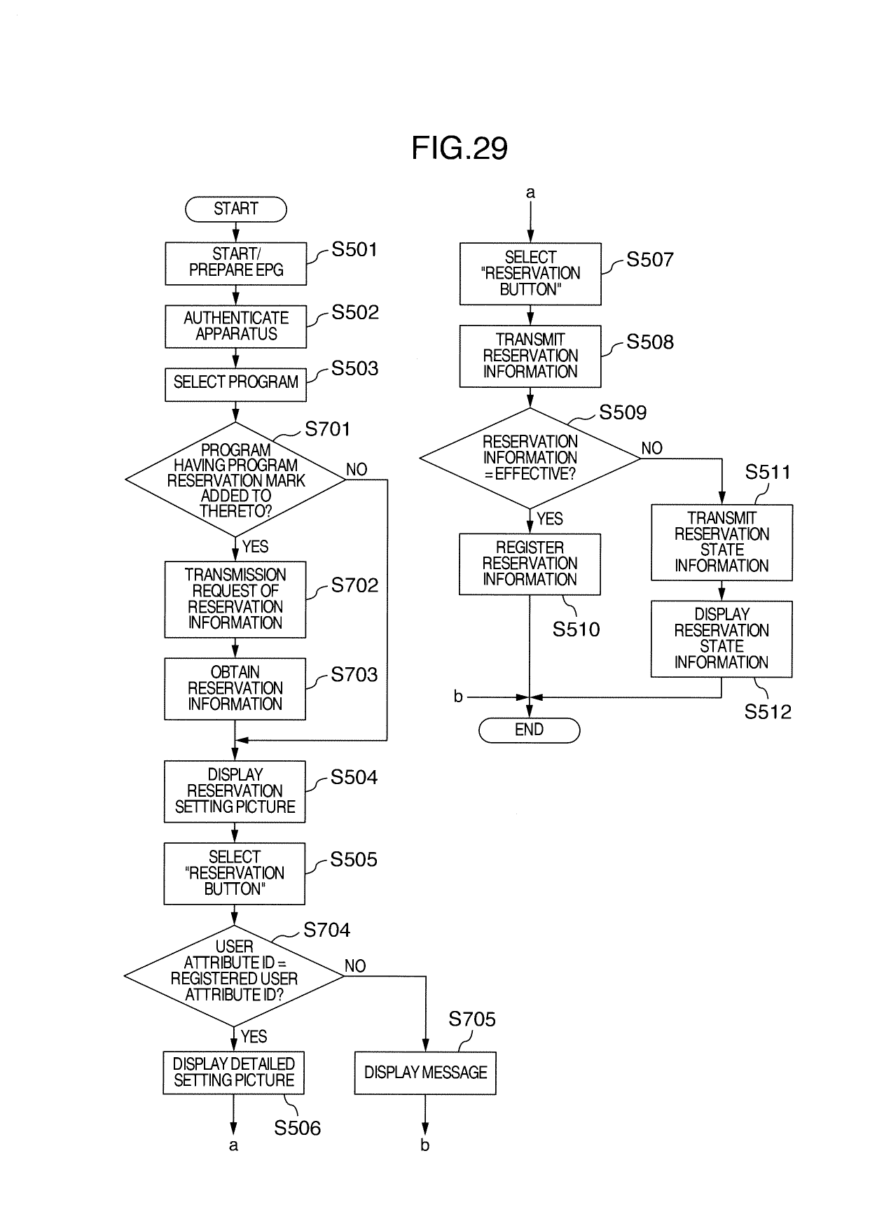

FIG. 28 is a flowchart showing an example of operation sequence at the time of program reservation using EPG in the embodiment. FIG. 29 is a flowchart showing an example of operation sequence in case where program reservation contents are changed in the embodiment.

In FIG. 28 of the embodiment, step S601 is added to operation sequence of FIG. 23 of the seventh embodiment and in FIG. 29, steps S701 and S702 are added. Steps S501, S502 and S509 to S512 are the same as FIG. 23 and detailed description thereof is omitted.

Referring now to FIG. 28, operation at the time of program reservation using EPG is described.

As shown in FIG. 17, when program 210 having no program reservation mark is selected by input unit 20 (S503), controller 17 of wireless terminal 15 prepares reservation information on the basis of program information on EPG screen prepared by EPG preparation module 3101 and displays reservation setting screen 213 as shown in FIG. 24 on display 19 (S504). When “reservation button”204 is selected on reservation setting screen 213 (S505), controller 17 displays detailed reservation setting screen 215 as shown in FIG. 25 on display 19 (S506).

In the detailed reservation setting screen 215, when “reserving button” 207 is selected (S507) apparatus authentication module 3104 reads out user attribute ID 217 from storage 8 (S601) and controller 17 transmits reservation setting state and user attribute ID 217 as reservation information to controller 4 of television receiver 1 through communication I/F 16 and communication I/F 12 (S508).

Furthermore, similarly to step of FIG. 23, when reservation information is effective reservation information is registered in recording data 2203.

Referring now to FIG. 29, correction operation of program reservation contents is described.

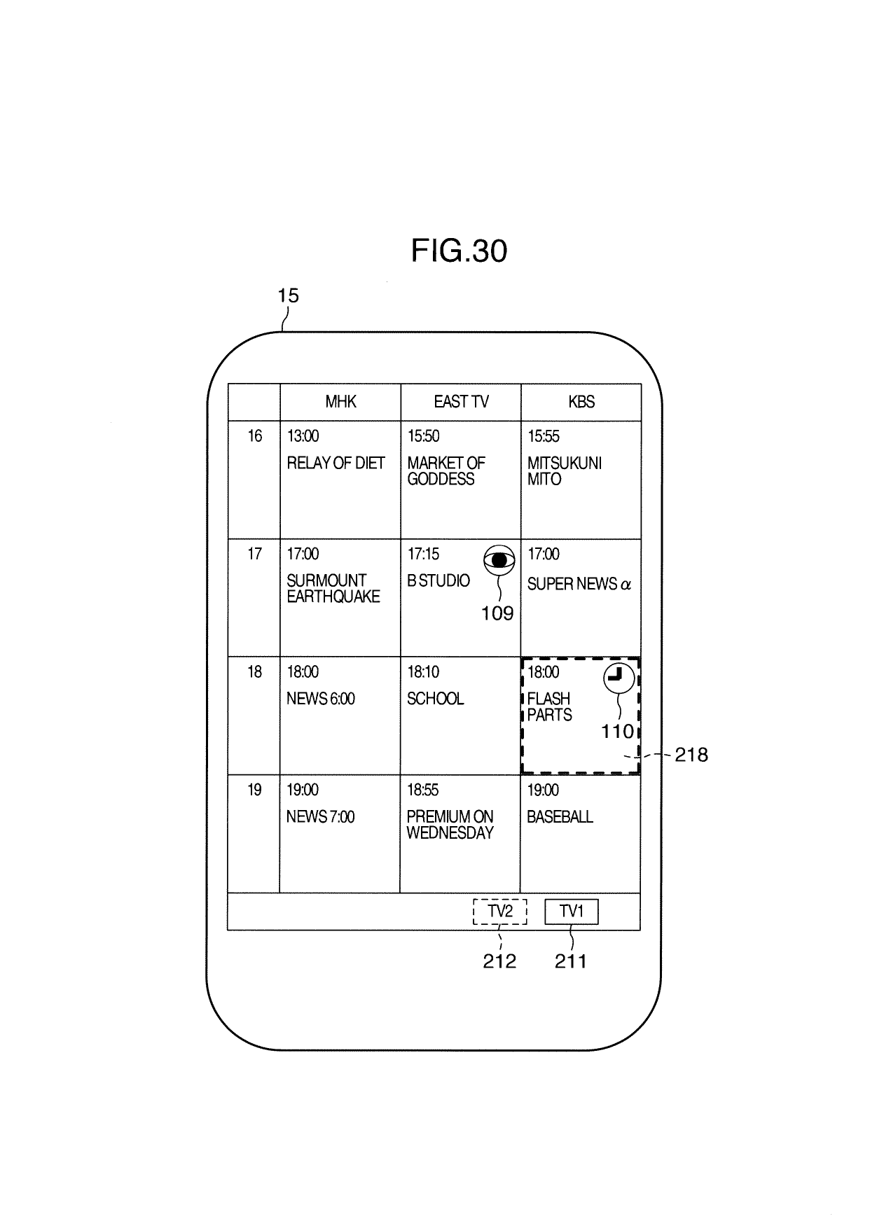

FIG. 30 shows an example of EPG screen displayed when program 218 having program reservation mark added thereto is selected.

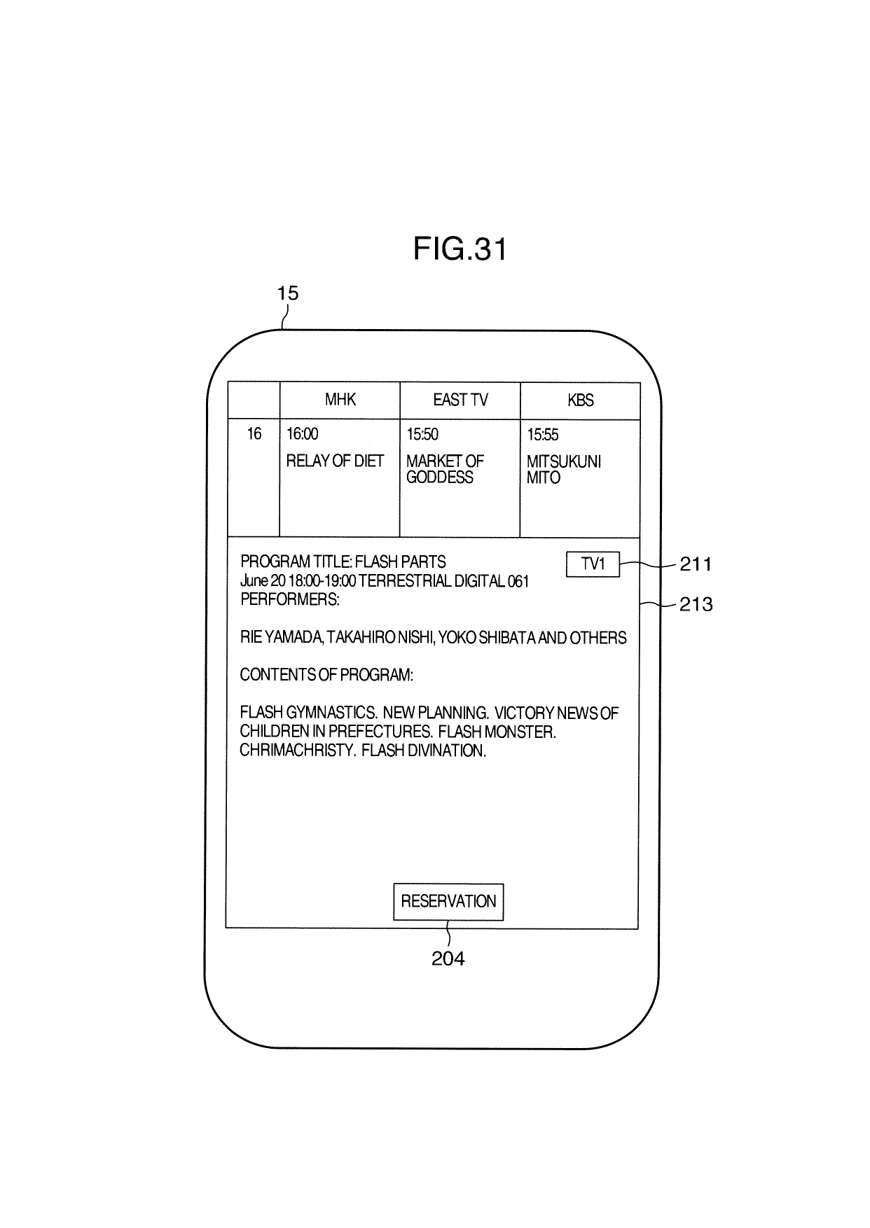

As shown in FIG. 30, when program 218 having program reservation mark is selected by input unit 20 (S503), controller 17 of wireless terminal 15 issues transmission request of reservation information (S702) to obtain reservation information from television receiver 1 (S703) and stores reservation information in program reservation data 3201 of storage 25 temporarily since program reservation mark is added to program (YES of S701). Further, reservation setting screen 213 as shown in FIG. 31 is displayed on display 19 (S504).

FIG. 31 shows a display example of reservation setting screen 213.

When “reservation button” 204 of FIG. 31 is selected (S505), program reservation module 3102 of wireless terminal 15 obtains reservation information from television receiver 1 in accordance with the same procedure as FIG. 12 and transmits reservation setting state as reservation information to program reservation module 2102 of television receiver 1 through communication I/F 16 and communication I/F 12 (S508).

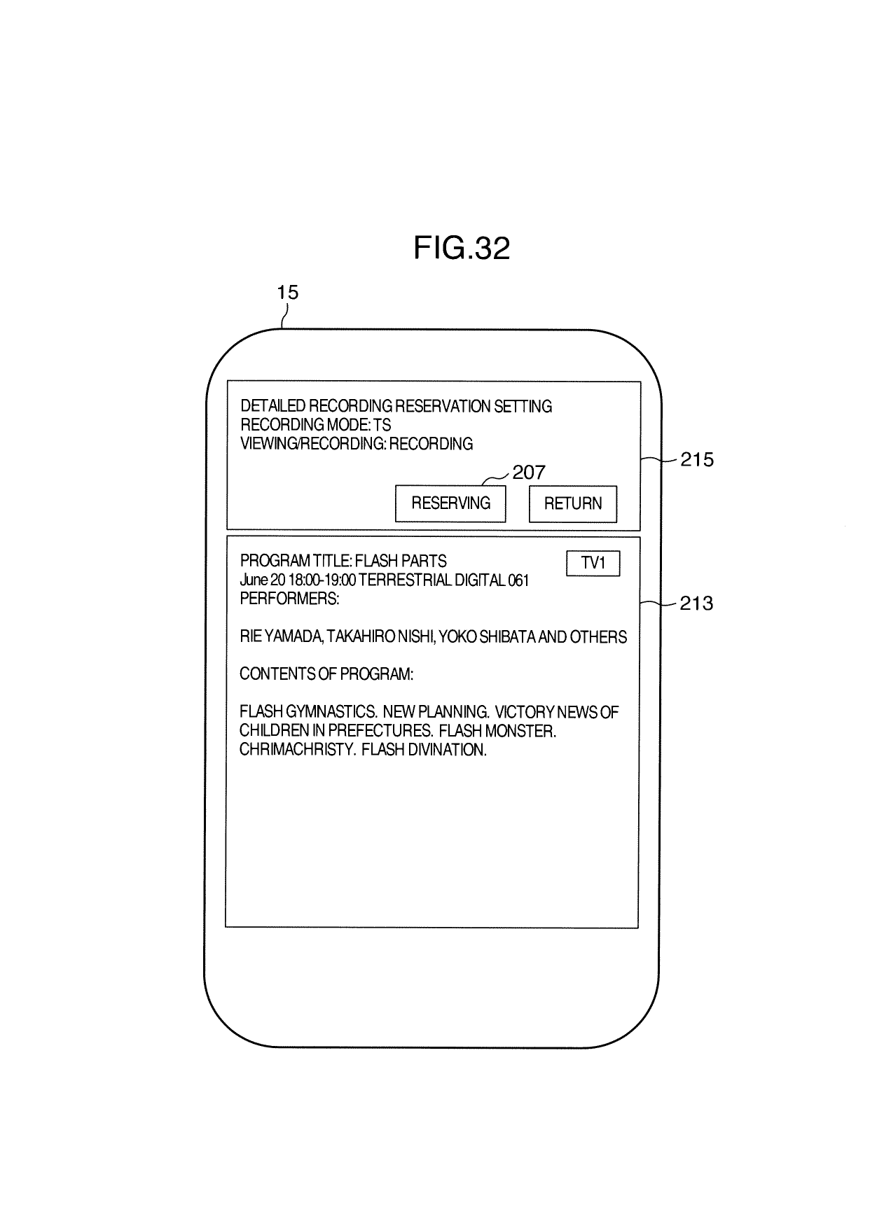

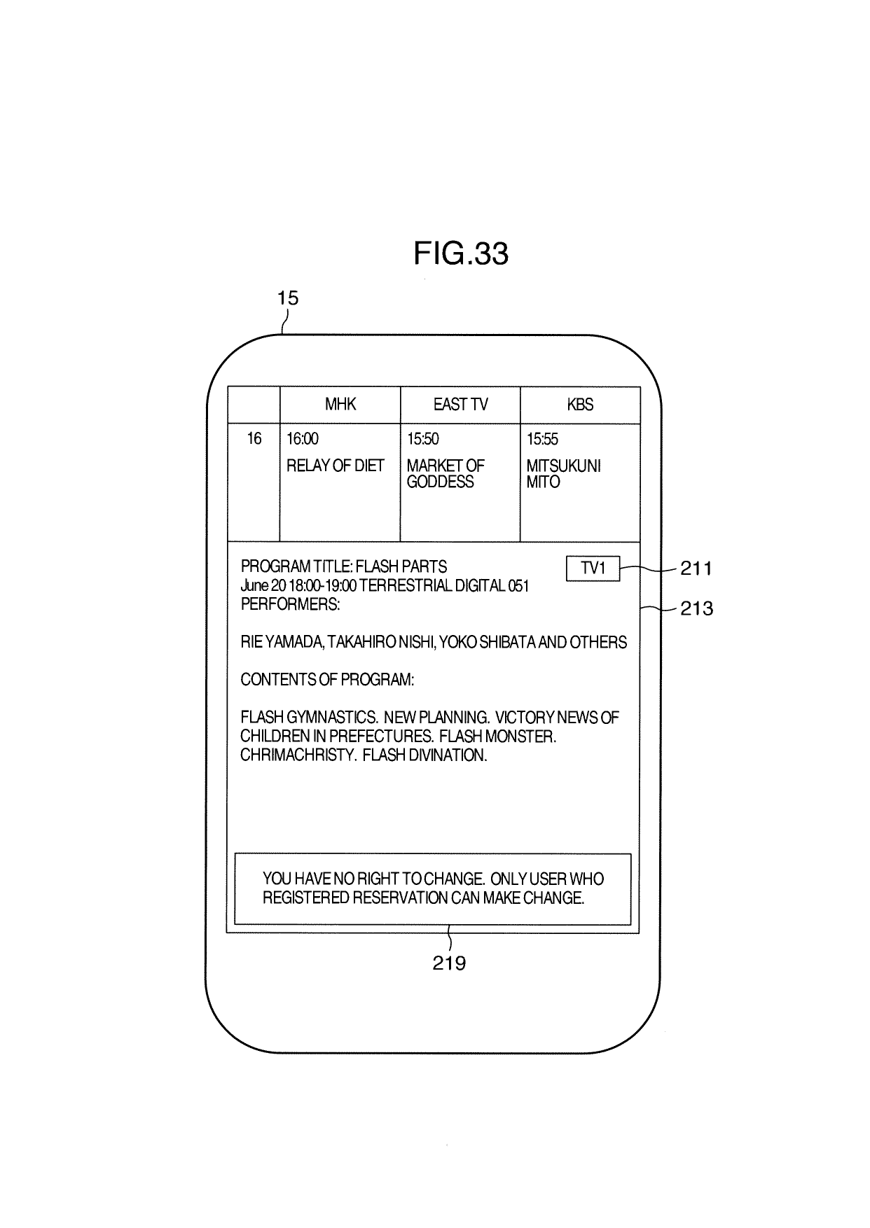

Controller 17 compares user attribute ID 217 registered in reservation information with user attribute ID obtained from apparatus authentication module 3104 and when both of user attribute ID's are identical (YES of S704), detailed reservation setting screen 215 as shown in FIG. 32 is displayed (S506). When both are not identical (NO of S704), reservation state information indication 219 as shown in FIG. 33 is displayed (S705) and message contents to the effect that “you have no right to change” are indicated to user.

FIG. 32 shows a display example of detailed reservation setting screen 213. FIG. 33 shows a display example of reservation state information indication 219.

Further, similarly to steps of FIG. 23, when corrected reservation information is Effective, reservation information is registered in recording data 2203.

In the embodiment, description has been made to the case where only wireless terminal 15 is connected, although even when there are plural wireless terminals, user attribute ID's inherent to wireless terminals can be produced to identify wireless terminals similarly.

Further, as a modification example, there is a case where mismatching occurs in state when operation is made in television receiver in case where program reservation is made or program reservation contents are updated in wireless terminal, although when operation of program reservation is going to be made in television receiver in case where television receiver permits connection of wireless terminal, message can be displayed or operation can be limited.

As described above, limitation can be set so that program reservation of television receiver cannot be changed from wireless terminal of user except user who has registered program reservation.

### Embodiment 9

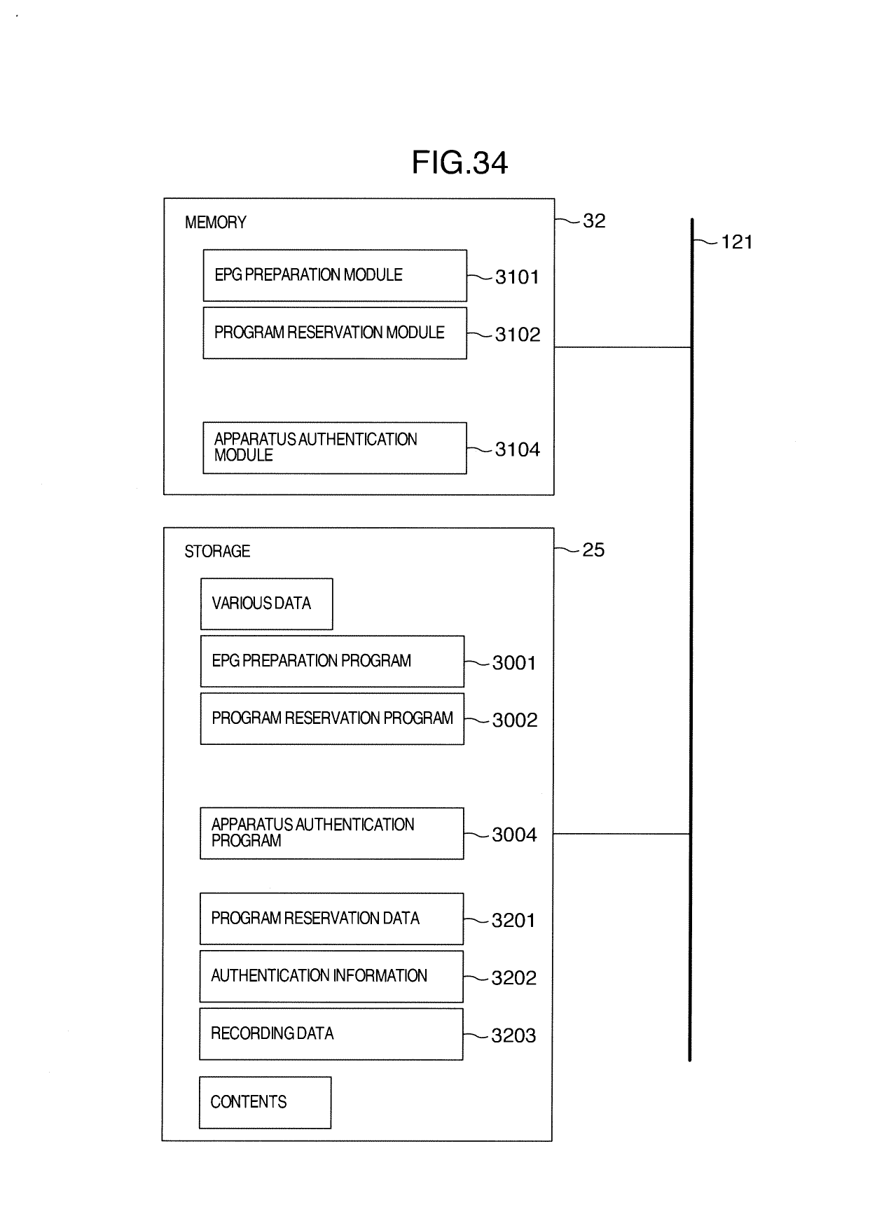

The ninth embodiment according to the present invention is now described with reference to FIGS. 34 to 40.

In the embodiment, description about different poi s is emphasized as compared with the seventh embodiment.

FIG. 34 schematically illustrates storage 25 and memory 32 used in wireless terminal 15. In FIG. 34, recording data 3203 is stored in storage 25 in addition to the seventh embodiment and even wireless terminal 15 has the function capable of making program reservation. Television receiver or wireless terminal is set to program reservation as object apparatus of program reservation.

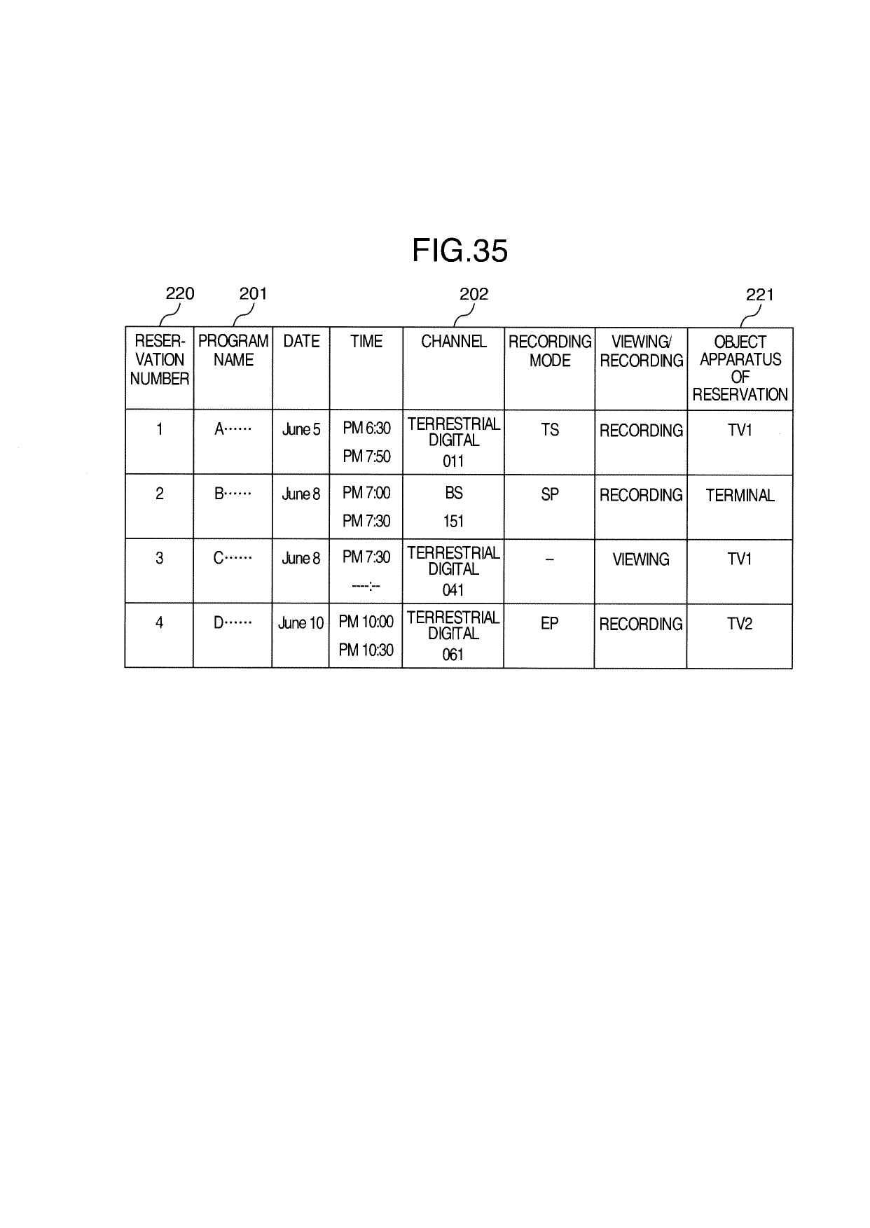

Referring now to FIG. 35, data format concerning network terminal system of the embodiment is described. FIG. 35 shows an example of data format for a list of reservation information of plural programs.

As shown in FIG. 35, reservation information includes data concerning setting number 220, program name 201, date, time, channel 202, recording mode, viewing/recording and object apparatus of setting 221, and setting number 220 and object apparatus of setting 221 are added to FIG. 10 of the third embodiment. Setting number 220 is used for description of identifying reservation contents when plural settings are made, although setting number is not essentially different from the third embodiment and it is not limited to use setting number in the third embodiment.

Further in the embodiment, television receivers 1 and 24 and wireless terminal 15 are described as “TV1”, “TV2” and “TERMINAL” as object apparatuses 221 of setting, respectively.

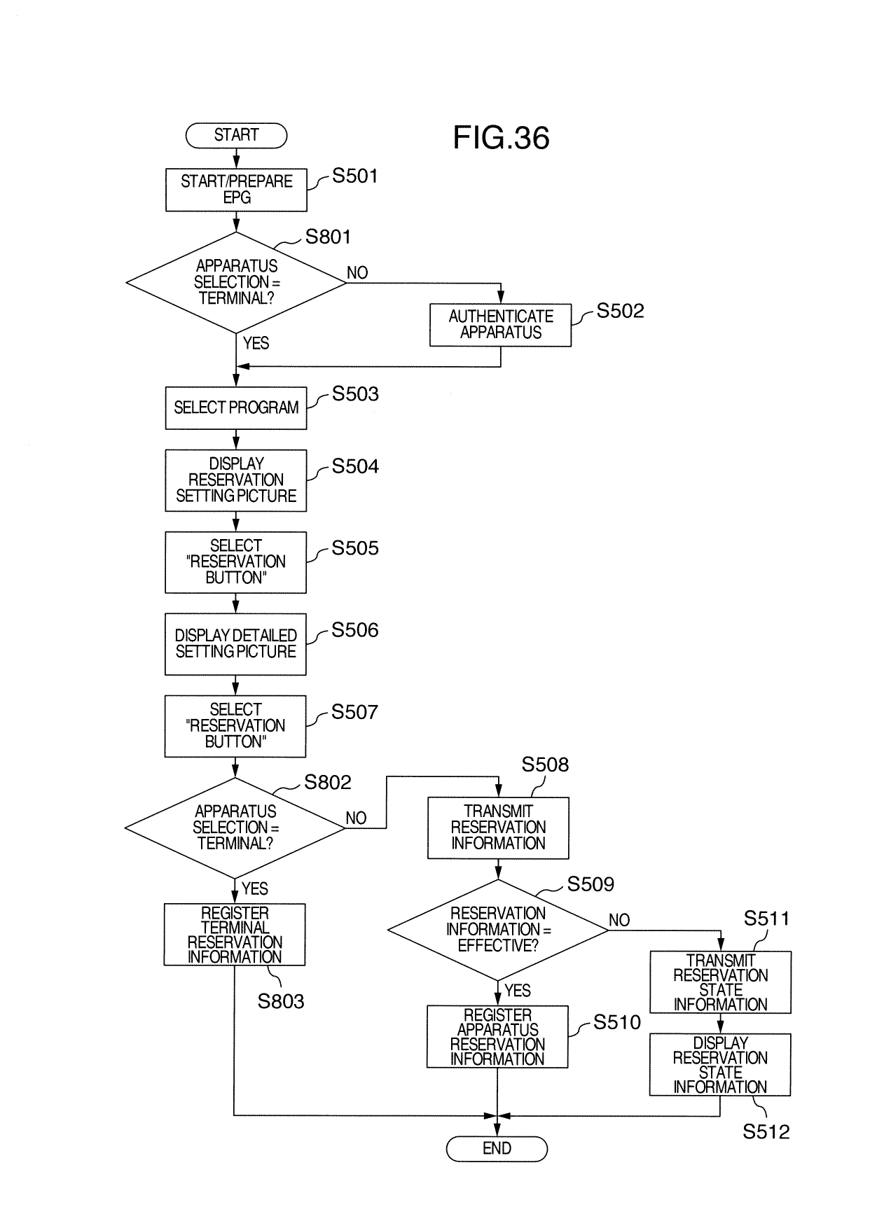

FIG. 36 is a flowchart showing an example of operation sequence a the time of program reservation using EPG in the embodiment.

In the embodiment, steps S801, S802 and S803 are added in FIG. 36 in addition to steps in FIG. 23 of the seventh embodiment. In steps S801 and S802, it is judged whether program reservation is made in wireless terminal or television receiver. Further, in step S803, program reservation data is stored in program reservation data 3201. Steps S502 and S508 to S512 are the same as those of FIG. 23 and detailed description thereof is omitted.

Referring now to FIG. 36, program reservation operation using EPG is described.

Description is made to the case where program reservation is made from program guide displayed in EPG screen of display 19 by input unit 20.

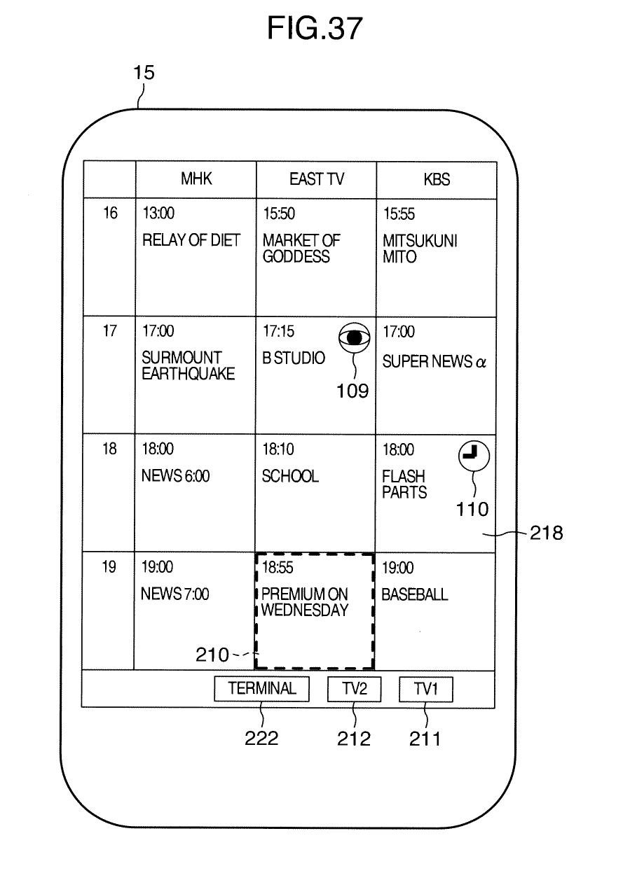

When EPG preparation module 3101 receives EPG start command by input unit 20, EPG preparation module 3101 prepares EPG screen as shown in FIG. 37 (S501).

FIG. 37 shows an example of EPG screen displayed when program 210 having no program reservation mark is selected.

Authenticated apparatus indications 211 and 212 and terminal selection indication 222 for selecting wireless terminal are displayed at lower part of EPG screen of FIG. 37. In the embodiment, authenticated apparatus indications 211 and 212 represent television receivers 1 (TV1) and 24 (TV2), respectively, and it is shown that authentication information set in television receiver 1 or 24 beforehand is inputted and authentication is successful. Information of apparatus which is not authenticated or fails in authentication is not displayed individually.

Next, operation in the case where terminal selection indication 222 is selected in FIG. 37 is described. Operation at the time that authenticated apparatus indications 211 and 212 are selected in FIG. 37 is the same as that of FIG. 23 of the seventh embodiment and accordingly description thereof is omitted.

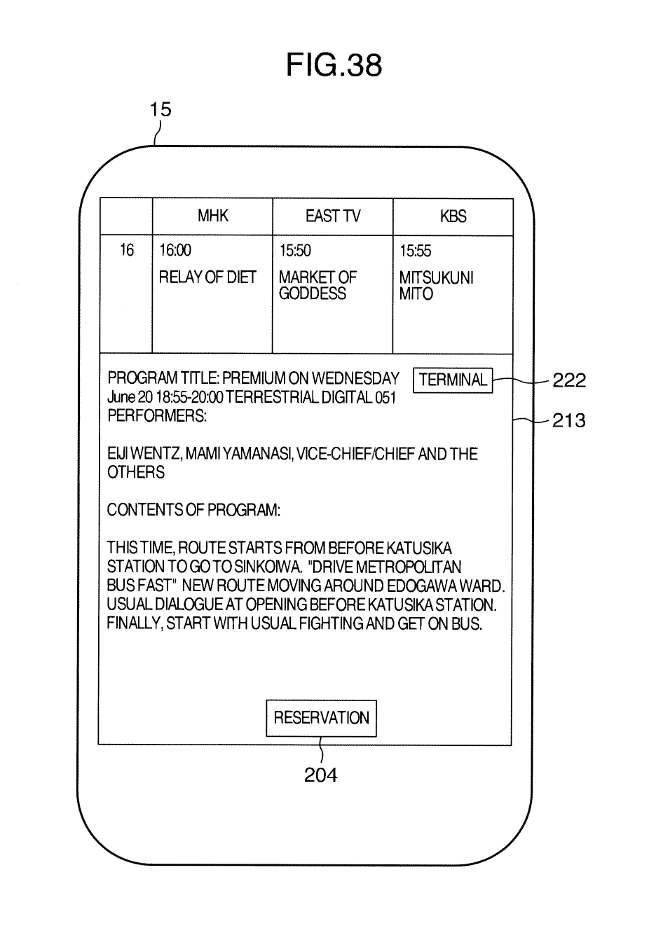

As shown in FIG. 37, when terminal selection indication 222 is selected by input unit 20 (YES of S801) and program 210 having no program reservation mark is selected (S503), program reservation module 3102 prepares reservation information from program information on EPG screen prepared by EPG preparation module 3101 and displays prepared reservation setting screen 214 on display 19 as shown in FIG. 38 (S504).

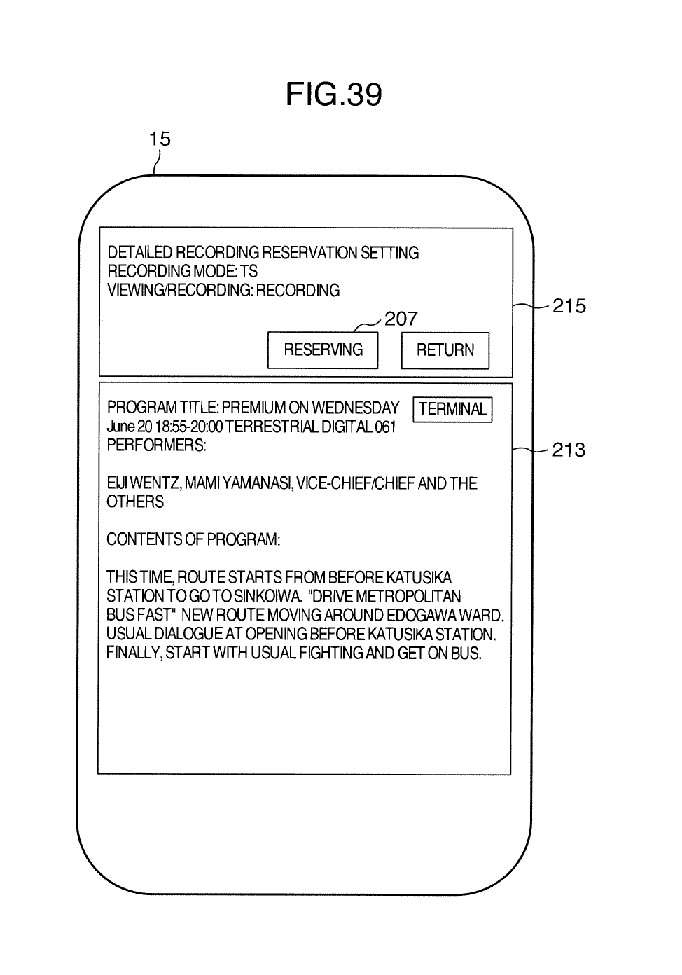

When “reservation button” 204 is selected in FIG. 38 (S505), detailed reservation setting screen 215 is displayed as shown in FIG. 39 (S506).

FIG. 38 shows a display example of reservation setting screen 213. FIG. 39 shows a display example of detailed reservation setting screen 215.

When “reserving button 207 is selected in FIG. 39 (S507), program reservation module 3102 stores reservation information in program reservation data 3203 (S803) since program reservation is made by wireless terminal 15 (YES of S802).

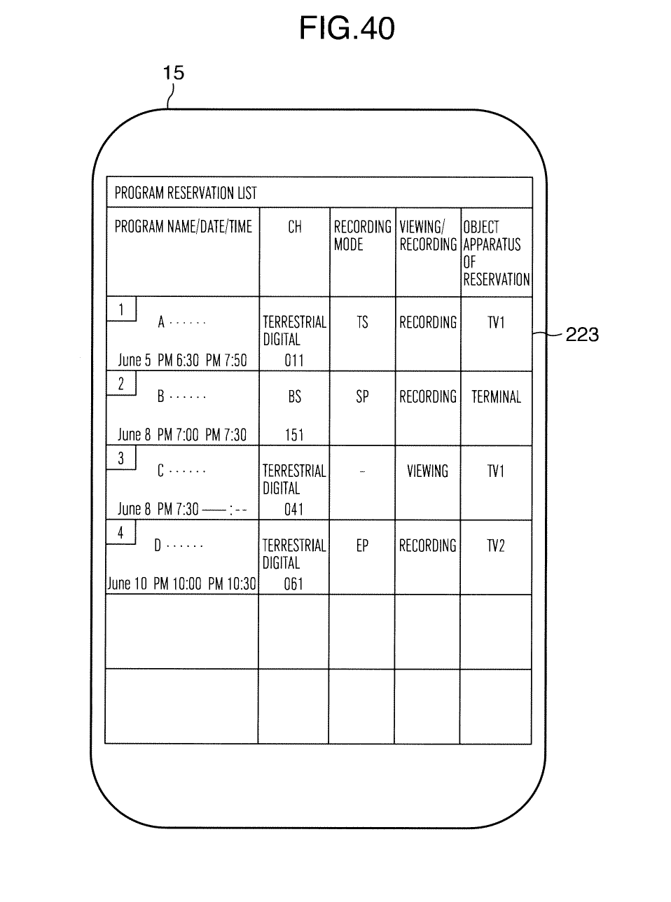

FIG. 40 shows an example of program reservation list displayed in wireless terminal 15. Program reservation module 3102 obtains reservation information from television receivers and prepares program reservation list 223 containing reservation in wireless terminal to be displayed on display 19, so that user can confirm reservation contents. Further, input unit 20 is used to correct object apparatus of setting 221, so that program reservation in television receiver 1 can be changed to program reservation in television receiver 24, for example, and accordingly even when program reservation cannot be made due to overlap of programs, object apparatus 221 of setting can be changed, so that program reservation can be made.

Furthermore, as modification example, the ninth embodiment can be combined with the eighth embodiment, so that correction of program reservation or the like can be limited to specified user.

As described above, wireless terminal and television receivers which are object apparatuses of setting can make program reservation in the same manner seamlessly. Further, setting overlapping between object apparatuses of setting can be canceled and setting can be changed over to unoccupied apparatus to thereby improve usability.

The present invention is not limited to the above embodiments and includes various modification examples. For example, in the above embodiments, the whole system is described in detail in order to be easily understood the present invention and the present invention is not necessarily limited to the system including all constituent elements described above. Further, part of configuration of a certain embodiment can be replaced by configuration of another embodiment and configuration of another embodiment can be added to configuration of a certain embodiment. Moreover, addition, deletion and replacement of part of configuration of embodiments can be made.

Further, part or all of the above configuration, function, processing units, processing means and the like may be realized in hardware by designing them by integrated circuits, for example. In addition, the above configuration and function may be realized by software by making processor interpret programs realizing respective functions and execute programs. Information such as programs, tables and files used to realize functions can be stored in recording apparatus such as memory, hard disk and SSD (Solid State Drive) or recording media such as IC card, SD card and DVD.

Further, only control lines and information lines considered to be required

for description are shown and all of control lines and information lines are not necessarily shown from the point of view of product. Actually, it may be considered that almost all constituent elements are connected to one another.

Furthermore, in the embodiments, TV1, TV2 and the like having display 11 are used to describe the embodiments, although the present invention can be implemented similarly using recorder or the like having display provided externally.

1. A wireless terminal connected through a network to a program receiving device which receives programs and identification information to identify programs to be received in future and prepares reservation information containing the identification information for reserved program, the wireless terminal comprising:
a receiver to receive the reservation information from the program receiving device and receive program related information concerning the programs, and
a display to display the program related information of the programs identified by the identification information contained in the reservation information from among the program related information received by the receiver while displaying distinguishable indication from the program related information of other programs additionally.

2. A wireless terminal according to claim 1, comprising:
an input unit to receive user's operation;
a reservation information change unit to change the reservation information on the basis of information of the operation received by the input unit; and
a transmission unit to transmit the reservation information changed by the reservation information change unit to the program receiving device which performs program reservation on the basis of the reservation information.

3. A wireless terminal according to claim 1, wherein
the receiver receives identification information of program being selected for identifying the program being selected from the program receiving device which selects the program received by the receiver, and
the display displays program related information of program identified by the identification information of program being selected on the basis of the identification information of program being selected.

4. A wireless terminal according to claim 1, wherein
the receiver receives, from the program receiving device which prepares an electronic program guide which is a list of programs to be received, allocation information representing allocation of programs of the electronic program guide, and
the display displays the electronic program guide in which programs are allocated on the basis of the allocation information.

5. An information processing method in a wireless terminal connected through a network to a program receiving device which receives programs and identification information to identify programs to be received in future and prepares reservation information containing the identification information for reserved program, the information processing method comprising:
receiving the reservation information from the program receiving device;
receiving program related information concerning the programs, and
displaying the program related information of the programs identified by the identification information contained in the reservation information from among the received program related information while displaying distinguishable indication from the program related information of other programs additionally.

6. An information processing method according to claim 5, further comprising:
receiving user's operation;
changing the reservation information on the basis of information of the received operation; and
transmitting the changed reservation information to the program receiving device which performs program reservation on the basis of the reservation information.

7. An information processing method according to claim 5, further comprising:
receiving identification information of program being selected for identifying the program being elected from the program receiving device which selects the program received, and
displaying program related information of program identified by the identification information of program being selected on the basis of the identification information of program being selected.

8. An information processing method according to claim 5, further comprising:
receiving, from the program receiving device which prepares an electronic program guide which is a list of programs to be received, allocation information representing allocation of programs of the electronic program guide, and
displaying the electronic program guide in which programs are allocated on the basis of the allocation information.

9. A system comprising a program receiving device and a wireless terminal, wherein
the program receiving device comprises:
a first receiving unit to receive programs and identification information to identify program to be received in future;
a program reservation module to prepare reservation information containing the identification information for reserved program; and
a communication unit to transmit the reservation information to the wireless Terminal; and
the wireless terminal comprises:
a second receiving unit to receive program related information concerning the programs and the reservation information transmitted from the program receiving device; and
a display to display the program related information of the programs identified by the identification information contained in the reservation information from among the program related information received by the second receiving unit while displaying distinguishable indication from the program related information of other programs additionally.

10. A system according to claim 9, wherein
the program reservation unit of the program receiving device performs program reservation on the basis of the reservation information, and
the wireless terminal comprises:
an input unit to receive user's operation;
a reservation information change unit to change the reservation information on the basis of information of the operation received by the input unit; and
a transmission unit to transmit the reservation information changed by the reservation information change unit to the program receiving device;
the communication unit of the program receiving device receiving the reservation information changed from the wireless terminal.

11. A system according to claim 9, wherein
the program receiving device comprises a selector to select the program received by the first receiving unit, and
the communication unit transmits, when the selector is selecting a program, identification information of program being selected for identifying the program being selected to the wireless terminal,
the display displaying the program related information of the program identified by the identification information of program being selected on the basis of the identification information of program being selected.

12. A system according to claim 9, wherein
the program receiving device comprises a program guide preparation module to prepare an electronic program guide which is a list of programs to be received by the first receiving unit, and
the communication unit of the program receiving device transmits allocation information representing allocation of programs of the electronic program guide to the wireless terminal,
the display of the wireless terminal displaying the electronic program guide in which programs are allocated on the basis of the allocation information.

13. An information processing method used in a system comprising a program receiving device and a wireless terminal, wherein
the program receiving device comprises:
receiving programs and identification information to identify program to be received in future;
preparing reservation information containing the identification information for reserved program; and
transmitting the reservation information to the wireless terminal; and
the wireless terminal comprises:
receiving program related information concerning the programs and the reservation information transmitted from the program receiving device; and
displaying the program related information of the programs identified by the identification information contained in the reservation information from among the received program related information while displaying distinguishable indication from the program related information of other programs additionally.

14. An information processing method according to claim 13, wherein
the wireless terminal comprises:
receiving user's operation;
changing the reservation information on the basis of information of the received operation; and
transmitting the changed reservation information to the program receiving device; and
the program receiving device comprises:
receiving the changed reservation information from the wireless terminal; and
performing program reservation on the basis of the reservation information.

15. An information processing method according to claim 13, wherein
the program receiving device comprises:
selecting the program to be received; and
transmitting, when a program is being selected, identification information of program being selected for identifying the program being selected to the wireless terminal;
the wireless terminal comprises:
displaying the program related information of the program identified by the identification information of program being selected on the basis of the identification information of program being selected.

16. An information processing method according to claim 13, wherein
the program receiving device comprises:
preparing an electronic program guide which is a list of programs to be received;
transmitting allocation information representing allocation of programs of the electronic program guide to the wireless terminal;
the wireless terminal comprises:
displaying the electronic program guide in which programs are allocated on the basis of the allocation information.
